(19) United States
(12) Patent Application Publication
(10) Pub. No.: US 2016/0217551 A1
(43) Pub. Date: Jul. 28, 2016

(54) METHOD OF CONFIGURING SCREEN, ELECTRONIC DEVICE, AND STORAGE MEDIUM

(71) Applicant: Samsung Electronics Co., Ltd., Gyeonggi-do (KR)

(72) Inventors: Moon-Soo KIM, Seoul (KR); Jung-Hyun KIM, Gyeonggi-do (KR); Jung-Eun LEE, Gyeonggi-do (KR); Dong-Ho JANG, Gyeonggi-do (KR); Song-Hee JUNG, Chungcheongbuk-do (KR)

(21) Appl. No.: 15/004,249

(22) Filed: Jan. 22, 2016

(30) Foreign Application Priority Data
Jan. 23, 2015 (KR) 10-2015-0011382

(51) Int. Cl. G06T 3/00; G09G 5/00; G06T 11/00

(52) U.S. Cl. CPC G06T 3/0093; G06T 3/0012; G06T 11/00; G09G 5/005; G06T 2200/16

(57) ABSTRACT

A method comprising: acquiring, by an electronic device, a first image; acquiring a stretch state of a stretchable display of the electronic device; generating, by the electronic device, a second image based on the first image and the stretch state; and displaying the second image on the stretchable display.

### CLAIM OF PRIORITY

This application claims priority under 35 U.S.C. §119(a) to Korean Application Serial No. 10-2015-0011382, which was filed in the Korean Intellectual Property Office on Jan. 23, 2015, the entire content of which is hereby incorporated by reference.

### TECHNICAL FIELD

The present disclosure relates to electronic devices, in general, and more particularly to a method of configuring screen, electronic device, and storage medium.

### BACKGROUND

These days, a technology related to a stretchable display, which is flexible by a force applied from the outside, is being developed. The stretchable display may change an area of a screen by the applied force and, accordingly, a user may view the screen displayed on the display with various areas according to a user's taste.

The stretchable display may display input image data. The stretchable display may display the input image data without any separate processing process considering the change in the display size.

### SUMMARY

According to aspects of the disclosure, a method is provided comprising: acquiring, by an electronic device, a first image; acquiring a stretch state of a stretchable display of the electronic device; generating, by the electronic device, a second image based on the first image and the stretch state; and displaying the second image on the stretchable display.

According to aspects of the disclosure, a method is provided for use in an electronic device comprising: displaying a first image on a stretchable display of the electronic device, the stretchable display having a first size; detecting that the stretchable display is stretched from the first size to a second size; and displaying a second image that is generated by resizing the first image to an aspect ratio that is selected by the electronic device based on the second size.

According to aspects of the disclosure, an electronic device is provided comprising: a memory; a stretchable display; a sensor module; and at least one processor operatively coupled to the memory, configured to: acquire a first image; acquire a stretch state of the stretchable display by using the sensor module; generate a second image based on the first image and the stretch state; and display the second image on the stretchable display According to aspects of the disclosure, a machine-readable storage medium is provided that stores one or more processor-executable instructions, which when executed by at least one processor cause the at least one processor to perform a method comprising the steps of: acquiring a first image; acquiring a stretch state of a stretchable display; generating a second image based on the first image and the stretch state; and displaying the second image on the stretchable display.

According to aspects of the disclosure, an electronic device is provided comprising: a memory; a stretchable display; a detection layer that stretches together with the stretchable display; and a processor operatively coupled to the memory, configured to identify at least one of a stretch position of the stretchable display and a direction in which the stretchable display is stretched, based on a stretch state of the detection layer.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram of an example of a network environment, according to various embodiments of the present disclosure;

FIG. 2 is a block diagram of an example of a program module, according to various embodiments of the present disclosure;

FIG. 3 is a block diagram of an example of a screen configuration module, according to various embodiments of the present disclosure;

FIG. 4A is a flowchart of an example of a process, according to various embodiments of the present disclosure;

FIG. 4B is a flowchart of an example of a process, according to various embodiments of the present disclosure;

FIG. 5A is a flowchart of an example of a process, according to various embodiments of the present disclosure;

FIG. 5B is a flowchart of an example of a process, according to various embodiments of the present disclosure;

FIG. 6 is a diagram illustrating an example of a screen configuration process, according to various embodiments of the present disclosure;

FIG. 7 is a diagram illustrating an example of a screen configuration process, according to various embodiments of the present disclosure;

FIG. 8A is a side view of an example of an electronic device, according to various embodiments of the present disclosure;

FIG. 8B is a side view of an example of an electronic device, according to various embodiments of the present disclosure;

FIG. 8C is a side view of an example of an electronic device, according to various embodiments of the present disclosure

FIG. 9A illustrates measurements of a stretch state of an electronic device, according to various embodiments of the present disclosure;

FIG. 9B illustrates a connection of a stretch level measurement elements of an electronic device according to various embodiments of the present disclosure;

FIG. 9C illustrates side views of an electronic device, according to various embodiments of the present disclosure;

FIG. 9D illustrates side views of an electronic device, according to various embodiments of the present disclosure;

FIG. 9E illustrates a conceptual diagram illustrating a detection layer according to various embodiments of the present disclosure;

FIG. 9F illustrates a conceptual diagram illustrating a detection layer according to various embodiments of the present disclosure;

FIG. 9G illustrates a conceptual diagram illustrating a detection layer according to various embodiments of the present disclosure;

FIG. 9H illustrates a conceptual diagram illustrating a detection layer according to various embodiments of the present disclosure;

FIG. 9I illustrates a conceptual diagram illustrating a detection layer according to various embodiments of the present disclosure;

FIG. 9J illustrates measurements of a stretch state of an electronic device, according to various embodiments of the present disclosure;

FIG. 9K illustrates measurements of a stretch state of an electronic device, according to various embodiments of the present disclosure;

FIG. 9L illustrates measurements of a stretch state of an electronic device, according to various embodiments of the present disclosure;

FIG. 10 is a diagram illustrating an example of a stretchable display, according to various embodiments of the present disclosure;

FIG. 11A is a flowchart of an example of a process, according to various embodiments of the present disclosure;

FIG. 11B is a flowchart of an example of a process, according to various embodiments of the present disclosure;

FIG. 12A is a flowchart of an example of a process, according to various embodiments of the present disclosure;

FIG. 12B is a flowchart of an example of a process, according to various embodiments of the present disclosure;

FIG. 12C is a flowchart of an example of a process, according to various embodiments of the present disclosure;

FIG. 13 is a flowchart of an example of a process, according to various embodiments of the present disclosure;

FIG. 14A and FIG. 14B illustrate a screen configuration according to a stretch direction;

FIG. 15 is a flowchart illustrating a screen configuration method according to various embodiments of the present disclosure;

FIG. 16A illustrates an example of a screen configuration process, according to various embodiments;

FIG. 16B illustrates an example of a screen configuration process, according to various embodiments;

FIG. 16C illustrates an example of a screen configuration process, according to various embodiments;

FIG. 17A is a flowchart of an example of a process, according to various embodiments of the present disclosure;

FIG. 17B is a flowchart of an example of a process, according to various embodiments of the present disclosure;

FIG. 18A illustrates an example of a screen configuration process, according to various embodiments;

FIG. 18B illustrates an example of a screen configuration process, according to various embodiments;

FIG. 19 is a flowchart of an example of a process, according to various embodiments of the present disclosure;

FIG. 20A illustrates an example of a screen configuration process when a stretch level is larger than a threshold, according to various embodiments of the present disclosure;

FIG. 20B illustrates an example of a screen configuration process when a stretch level is larger than a threshold, according to various embodiments of the present disclosure;

FIG. 21 is a block diagram illustrating an example of a screen configuration process, according to various embodiments of the present disclosure;

FIG. 22A illustrates an example of a layer configuration process, according to various embodiments of the present disclosure;

FIG. 22B illustrates an example of a layer configuration process, according to various embodiments of the present disclosure;

FIG. 22C illustrates an example of a frame buffer, according to various embodiments of the present disclosure;

FIG. 22D illustrates an example of a frame buffer, according to various embodiments of the present disclosure;

FIG. 22E illustrates an example of an image displayed on a stretchable display, according to various embodiments of the present disclosure;

FIG. 22F illustrates an example of an image displayed on a stretchable display, according to various embodiments of the present disclosure;

FIG. 23 is a flowchart of an example of a process, according to various embodiments of the present disclosure;

FIG. 24 is a flowchart of an example of a process, according to various embodiments of the present disclosure;

FIG. 25A illustrates an example of a screen configuration process, according to various embodiments of the present disclosure;

FIG. 25B illustrates an example of a screen configuration process, according to various embodiments of the present disclosure;

FIG. 26 is a flowchart of an example of a process, according to various embodiments of the present disclosure;

FIG. 27 illustrates an example of an expansion of a tile, according to various embodiments of the present disclosure;

FIG. 28 illustrates an example of a second image when the tile of FIG. 27 is expanded, according to various embodiments of the present disclosure;

FIG. 29 is a flowchart of an example of a process, according to various embodiments of the present disclosure;

FIG. 30 is a diagram of an example of an RGB pixel array, according to various embodiments of the present disclosure; and

FIG. 31 is a block diagram of an example of an electronic device, according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

In the present disclosure, the expression “have”, “may have”, “include” or “may include” refers to the existence of a corresponding feature (e.g., numerical value, function, operation, or components such as elements), and does not exclude the existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. The above expressions are used merely for the purpose of distinguishing an element from the other elements. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic device for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

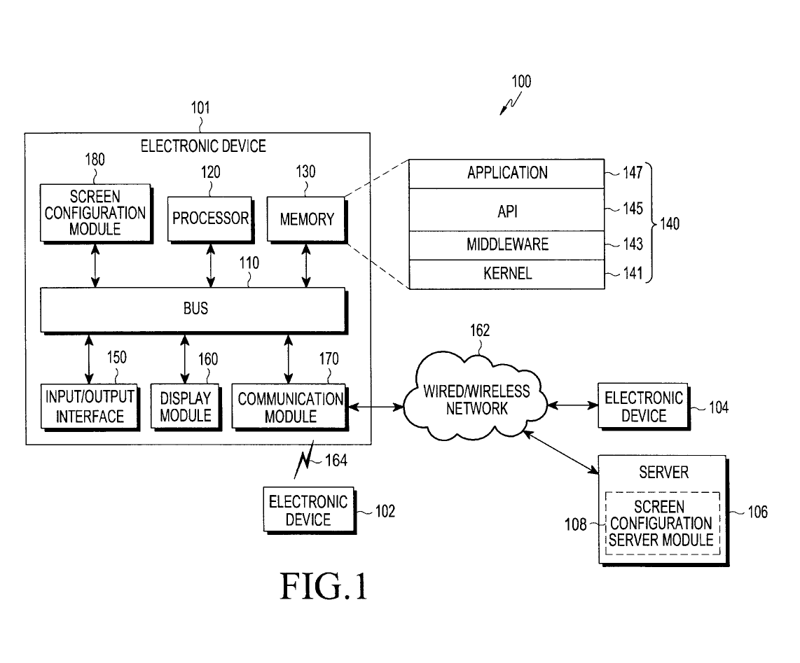

Referring to FIG. 1, an electronic device 101 within a network environment 100 according to various embodiments is described. The electronic device 101 may include a bus 110, a processor 120, a memory 130, an input/output interface 150, a display 160, a communication interface 170, and a screen configuration module 180. In some embodiments, the electronic device 101 may omit at least some of the above elements or further include other elements.

The bus 110 may include a circuit for connecting the elements 120 to 180 and transmitting communication between the elements (for example, control messages and/or data).

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. In some implementations, the processor 120 may include one or more of a Central Processing Unit (CPU), an Application Processor (AP), and a Communication Processor (CP). The processor 120 may control, for example, one or more other elements of the electronic device 101 and/or process an operation or data related to communication. The processor 120 may be called a controller or may include a controller as a part thereof.

The storage 130 may include any suitable type of volatile or non-volatile memory, such as Random-access Memory (RAM), Read-Only Memory (ROM), Network Accessible Storage (NAS), cloud storage, a Solid State Drive (SSD), etc. In operation, the memory 130 may store, for example, instructions or data related to at least one other element of the electronic device 101. According to an embodiment, the memory 130 may store software and/or a program 140. The program 140 may include, for example, a kernel 141, middleware 143, an Application Programming Interface (API) 145, and/or an application program (or “applications”) 147. At least some of the kernel 141, the middleware 143, and the API 145 may be referred to as an Operating System (OS).

For example, the kernel 141 may control or manage system resources (for example, the bus 110, the processor 120, and the memory 130) which are used to execute an operation or a function implemented in the other programs (for example, the middleware 143, the API 145, and the application programs 147). Furthermore, the kernel 141 may provide an interface through which the middleware 143, the API 145, or the application program 147 may access individual components of the electronic device 101 to control or manage system resources.

For example, the middleware 143 may serve as a relay for allowing the API 145 or the application programs 147 to communicate with the kernel 141 to exchange data. Furthermore, in regard to task requests received from the application program 147, the middleware 143 may perform a control (for example, scheduling or load balancing) for the task requests using, for example, a method of assigning at least one application a priority for using the system resources (for example, the bus 110, the processor 120, or the memory 130) of the electronic device 101.

The API 145 is an interface by which the applications 147 control functions provided from the kernel 141 or the middleware 143, and may include, for example, at least one interface or function (for example, instructions) for file control, window control, image processing, or text control.

In the specification, the applications may be referred to as an application program.

The input/output interface 150 may serve as an interface which may transmit instructions or data input from the user or another external device to other element(s) of the electronic device 101. Further, the input/output interface 150 may output instructions or data received from another element(s) of the electronic device 101 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (for example, text, images, videos, icons, or symbols) for users. The display 160 may include a touch screen and receive, for example, a touch input, a gesture input, a proximity input, or a hovering input using an electronic pen or a user's body part.

The display 160 may be, for example, a stretchable display. The display 160 may be expanded by a force applied from the outside. According to the expansion of the display 160, a display area may change.

The communication interface 170 may configure communication between, for example, the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may use, for example, at least one of LTE, LTE-A, CDMA, WCDMA, UMTS, WiBro, and GSM, for example, as a cellular communication protocol. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of telecommunication networks such as a computer network (for example, a LAN or a WAN), the Internet, and a telephone network.

Each of the first and second external electronic devices 102 and 104 may be a device which is the same type as or a different type from the electronic device 101. According to an embodiment, the server 106 may include a group of one or more servers. According to various embodiments, all or some of the operations performed by the electronic device 101 may be performed by another electronic device or a plurality of electronic devices (for example, the electronic device 102 or 104 or the server 106). According to an embodiment, when the electronic device 101 should perform some functions or services automatically or by request, the electronic device 101 may make a request for performing at least some of the functions related to the functions or services to another device (for example, the electronic device 102 or 104 or the server 106) instead of performing the functions or services by itself. The other electronic device (for example, the electronic device 102 or 104 or the server 106) may carry out the requested function or the additional function and transfer the result, obtained by carrying out the function, to the electronic device 101. The electronic device 101 may provide the requested functions or services based on the received result as it is or after additionally processing the received result. To achieve this, for example, cloud computing, distributed computing, or client-server computing technology may be used.

According to an embodiment, the screen configuration module 180 may support driving of the electronic device 101 by performing at least one of the operations (or functions) implemented by the electronic device 101. For example, the server 106 may include a screen configuration server module 108 capable of supporting the screen configuration module 180 implemented in the electronic device 101. For example, the screen configuration server module 108 includes one or more elements of the screen configuration module 180 and may perform (on behalf of the screen configuration module 180) at least one of the operations of the screen configuration module 180.

The screen configuration module 180 may process at least some of the information obtained from other elements (for example, at least one of the processor 120, the memory 130, the input/output interface 150, and the communication interface 170) and utilize the same in various manners. For example, the screen configuration module 180 may control at least some functions of the electronic device 101 by using the processor 120 or independently therefrom so that the electronic device 101 may interwork with other electronic devices (for example, the electronic device 102 or 104 or the server 106). The screen configuration module 180 may be integrated into the processor 120 or the communication interface 170. According to an embodiment, at least one component of the screen configuration module 180 may be included in the server 106 (for example, the screen configuration server module 108) and receive supporting of at least one operation implemented by the screen configuration module 180 from the server 106.

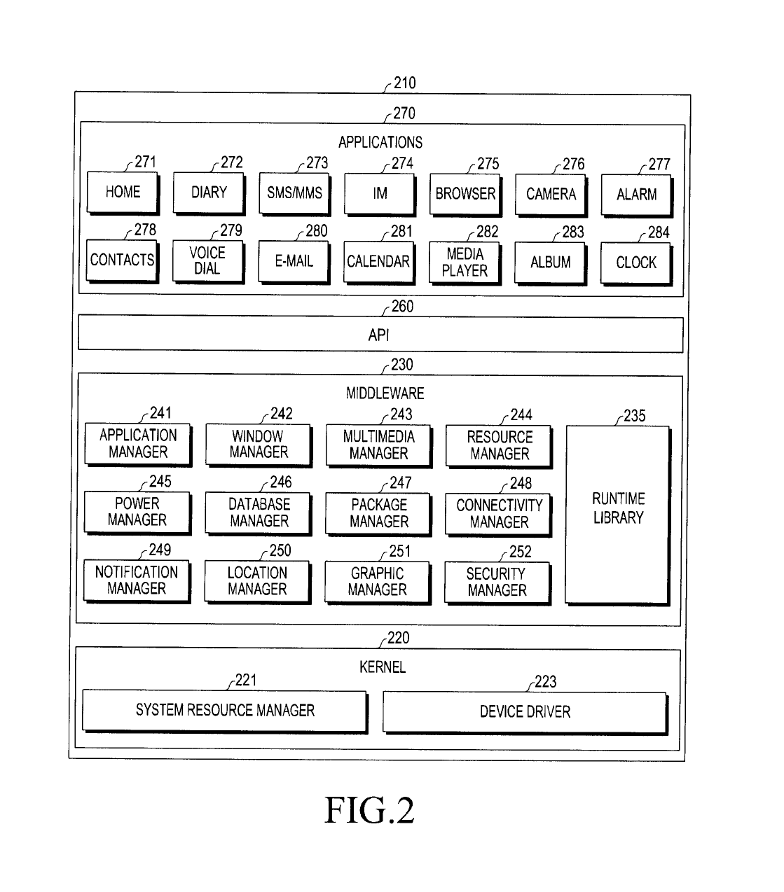

FIG. 2 is a block diagram 200 of a program module 210 according to various embodiments of the present disclosure. According to an embodiment, the program module 210 (for example, the program 140) may include an Operating System (OS) for controlling resources related to the electronic device (for example, the electronic device 101) and/or various applications (for example, the application program 147) executed in the operating system. The operating system may be, for example, Android, iOS, Windows, Symbian, Tizen, Bada, or the like.

The program module 210 may include a kernel 220, middleware 230, an Application Programming Interface (API) 260, and/or applications 270. At least some of the program module 210 may be preloaded in the electronic device or downloaded in the server (for example, the server 106).

The kernel 220 (for example, the kernel 141 of FIG. 1) may include, for example, a system resource manager 221 or a device driver 223. The system resource manager 221 may control, allocate, or collect the system resources. According to an embodiment, the system resource manager 221 may include a process manager, a memory manager, or a file system manager. The device driver 223 may include, for example, a display driver, a camera driver, a Bluetooth driver, a shared-memory driver, a USB driver, a keypad driver, a Wi-Fi driver, an audio driver, or an Inter-Process Communication (IPC) driver.

The middleware 230 may provide a function required by the applications 270 in common or provide various functions to the applications 270 through the API 260 so that the applications 270 may efficiently use limited system resources of the electronic device. According to an embodiment, the middleware 230 (for example, the middleware 143) may include, for example, at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252.

The runtime library 235 may include, for example, a library module that a compiler uses in order to add new functions through a programming language while the application 270 is executed. The runtime library 235 may perform input/output management, memory management, or a function for an arithmetic function.

The application manager 241 may manage, for example, a life cycle of at least one application among the applications 270. The window manager 242 may manage a GUI resource used in a screen. The multimedia manager 243 may detect a format required for reproducing various media files and encode or decode a media file using a codec appropriate for the corresponding format. The resource manager 244 may manage resources such as a source code, a memory or a storage space of at least one application among the applications 270.

The power manager 245 may operate together with, for example, a Basic Input/Output System (BIOS), so as to manage a battery or power and may provide power information required for the operation of the electronic device. The database manager 246 may generate, search for, or change a database to be used by at least one of the applications 270. The package manager 247 may manage the installation or updating of applications distributed in the form of a package file.

The connectivity manager 248 may manage wireless connections, for example, Wi-Fi or Bluetooth. The notification manager 249 may display or notify of an event such as a received message, an appointment, a proximity notification, and the like to a user without disturbance. The location manager 250 may manage location information of the electronic device. The graphic manager 251 may manage graphic effects to be provided to a user and user interfaces related to the graphic effects. The security manager 252 may provide various security functions required for system security or user authentication. According to an embodiment, when the electronic device (for example, electronic device 101) has a call function, the middleware 230 may further include a telephony manager for managing a voice call function or a video call function of the electronic device.

The middleware 230 may include a middleware module for forming a combination of various functions of the aforementioned components. The middleware 230 may provide a module specialized for each type of operating system in order to provide a differentiated function. In addition, a few existing elements may be dynamically removed from the middleware 230, or new elements may be added to the middleware 230.

The API 260 (for example, the API 145), which is a set of API programming functions, may be provided in a different configuration for each operating system. For example, in the case of Android or iOS, one API set may be provided for each platform. In the case of Tizen, two or more API sets may be provided for each platform.

The applications 270 (for example, the application programs 147) may include one or more of a home application 271, a dialer application 272, an SMS/MMS application 273, an Instant Message (IM) application 274, a browser application 275, a camera application 276, an alarm application 277, a contact information application 278, a voice dial application 279, an e-mail application 280, a calendar application 281, a media player application 282, an album application 283, a clock application 284, a health care application (for example, an application for measuring an amount of exercise or blood sugar), and an environmental information application (for example, an application for providing atmospheric pressure, humidity, or temperature information).

According to an embodiment, the applications 270 may include an application (hereinafter, referred to as an “information exchange application” for convenience of the description) supporting information exchange between the electronic device (for example, the electronic device 101) and external electronic devices (for example, the electronic devices 102 and 104). The information exchange application may include, for example, a notification relay application for transmitting predetermined information to the external electronic device, or a device management application for managing the external electronic device.

For example, the notification relay application may include a function of transferring, to the external electronic device (for example, the electronic device 102 or 104), notification information generated from other applications of the electronic device (for example, an SMS/MMS application, an e-mail application, a health management application, or an environmental information application). Further, the notification relay application may receive notification information from, for example, an external electronic device and provide the received notification information to a user. The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided by the external electronic device (for example, a telephone call service or a message service).

According to an embodiment, the applications 270 may include an application (for example, health management application) designated according to attributes (for example, attributes of the electronic device such as the type of electronic device which corresponds to a mobile medical device) of the external electronic device (for example, the electronic device 102 or 104). According to an embodiment, the applications 270 may include an application received from the external electronic device (for example, the server 106, or the electronic device 102 or 104). According to an embodiment, the applications 270 may include a preloaded application or a third party application which can be downloaded from the server. Names of the elements of the program module 210, according to the above-described embodiments of the present disclosure, may change depending on the type of OS.

According to various exemplary embodiments of the present disclosure, at least some of the program module 210 may be implemented in software, firmware, hardware, or a combination of two or more thereof. At least some of the programming module 210 may be implemented (for example, executed) by, for example, the processor (for example, the AP 210). At least some of the programming module 210 may include, for example, a module, program, routine, sets of instructions, process, or the like for performing one or more functions.

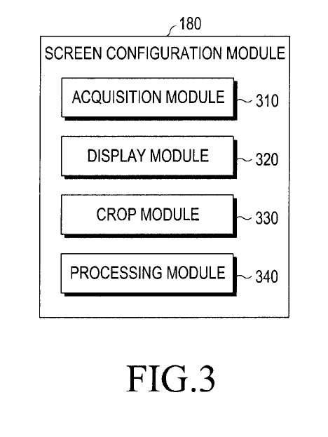

FIG. 3 is a block diagram of the screen configuration module 180 of the electronic device (for example, the electronic device 101) according to various embodiments of the present disclosure. Referring to FIG. 3, the screen configuration module 180 may include an acquisition module 310, a display module 320, and a processing module 340.

According to various embodiments of the present disclosure, the acquisition module 310 may acquire a first image. The acquisition module 310 may acquire a stretch state of the stretchable display. The processing module 340 may generate a second image by using the first image based on the acquired stretch state. The display module 320 may display the generated second image.

According to an embodiment, when the second image is displayed on the stretchable display, the processing module 340 may determine a horizontal-to-vertical ratio of the second image to have the same horizontal-to-vertical ratio as that of the first image.

According to an embodiment, the acquisition module 310 may acquire a stretch ratio of the stretchable display. The processing module 340 may determine the horizontal-to-vertical ratio of the second image based on the stretch ratio. The processing module 340 may generate the second image by compressing the first image by a reciprocal of the stretch ratio.

According to an embodiment, the processing module 340 may crop the first image corresponding to a first part area cropped from the entire image. The processing module 340 may crop a second part area from the entire image based on the acquired stretch state. The second image may be an image corresponding to the second part area. In an operation of acquiring the stretch state, the acquisition module 310 may acquire at least one of a stretch direction of the stretchable display and a size of the stretchable display. The processing module 340 may crop the second part area in accordance with at least one of the stretch direction and the size. When there is no data to be cropped in the entire image, the display module 320 may display the second image having a maximum size to be cropped.

According to an embodiment, the acquisition module 310 may acquire the stretch direction of the stretchable display. The display module 320 may display the second image at a location corresponding to the stretch direction.

According to an embodiment, in an operation of acquiring the stretch state, the acquisition module 310 may acquire a stretch level of the stretchable display. The display module 320 may display the second image based on the stretch level.

According to an embodiment, the processing module 340 may acquire display brightness of the second image based on the stretch state and to display the second image with the acquired brightness.

According to an embodiment, the acquisition module 310 may acquire the stretch level according to each tile of the stretchable display. The processing module 340 may generate a sub image according to each tile based on the stretch state. The processing module 340 may generate the sub image according to each tile by applying different stretch ratios to tiles having different stretch states.

The processing module 340 may display at least one of a black screen, a function tool, second image-related information, and a second image-related application in the remaining area except for the area of the stretched display in which the second image is displayed.

According to various embodiments of the present disclosure, the display module 320 may display the first image in accordance with a first size of the stretchable display. Further, in accordance with the stretching of the stretchable display to a second size from the first size, the display module 320 may display the second image corresponding to the second size at the same horizontal-to-vertical ratio as that of the first image.

According to various embodiments of the present disclosure, the processing module 340 may process sensed stretch-related data and determine a stretch level and a stretch position according to the processed data.

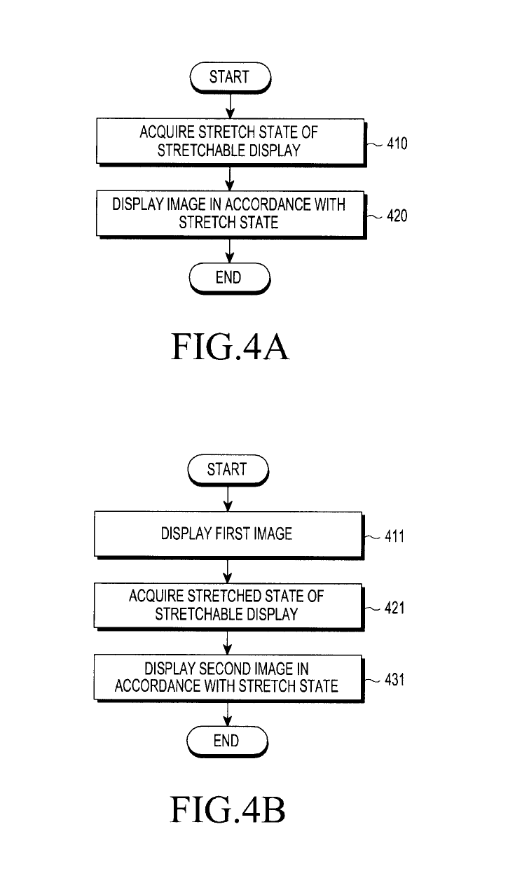

FIG. 4A is a flowchart illustrating a screen configuration method according to various embodiments of the present disclosure.

In operation 410, the electronic device 101 may acquire a stretch state of the stretchable display. The stretch state may include at least one of an area of the stretchable display, a stretch direction, a stretch ratio, and a stretch level after the stretching.

In operation 420, the electronic device 101 may display an image in accordance with the acquired stretch state. The electronic device 101 may receive image data to be displayed and display the image data in accordance with the stretch state. For example, the electronic device 101 may process and display the input image data in accordance with the area of the stretchable display after the stretching. For example, the electronic device 101 may process and display the input image data in accordance with the stretch direction. For example, the electronic device 101 may process and display the input image data in accordance with the stretch level. Meanwhile, the electronic device may process the input image data based on a combination of two or more of the area of the stretchable display, the stretch direction, and the stretch level and display the processed image data.

FIG. 4B is a flowchart illustrating a screen configuration method according to various embodiments of the present disclosure.

In operation 411, the electronic device 101 may display a first image. The electronic device 101 may display the first image in accordance with a first stretch state.

In operation 421, the electronic device 101 may acquire a stretch state of the stretchable display. For example, the electronic device 101 may acquire a change to a second stretch state from the first stretch state of the stretchable display. The electronic device 101 may acquire a difference between the second stretch state and the first stretch state. Alternatively, the electronic device 101 may acquire the second stretch state. The second stretch state may be different from the first stretch state.

In operation 431, the electronic device 101 may display a second image in accordance with the stretch state. For example, image data related to the first image and image data related to the second image may be the same as each other. The electronic device 101 may display the second image in accordance with the second stretch state. Since the first stretch state and the second stretch state are different from each other, the electronic device 101 may display the second image different from the first image.

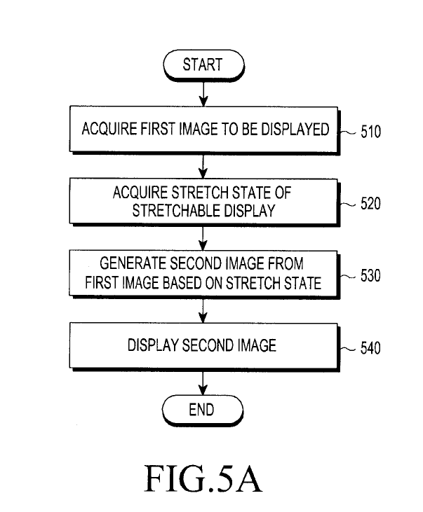

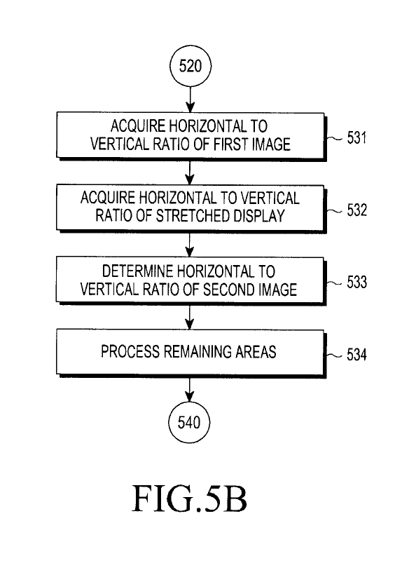

FIG. 5A is a flowchart illustrating a screen configuration method according to various embodiments of the present disclosure.

In operation 510, the electronic device 101 may acquire the first image to be displayed. The first image may be an image displayed in a state before the stretchable display is stretched. For example, the first image may be an image configured to conform to a predetermined image-related standard or unique setting of the electronic device 101.

In operation 520, the electronic device 101 may acquire a stretch state of the stretchable display.

In operation 530, the electronic device 101 may generate a second image by using the first image based on the stretch state. For example, when the second image is actually displayed on the stretchable display, on which the second image stretches, the electronic device 101 may generate a second image having the same horizontal-to-vertical ratio (e.g., aspect ratio) as that of the first image. Alternatively, the electronic device 101 may generate a second image having the same resolution as that of the first image. A more detailed description of the generation of the second image will be described below.

In operation 540, the electronic device 101 may display the second image. When the second image displayed, the second image may have the same horizontal-to-vertical ratio as that of the first image.

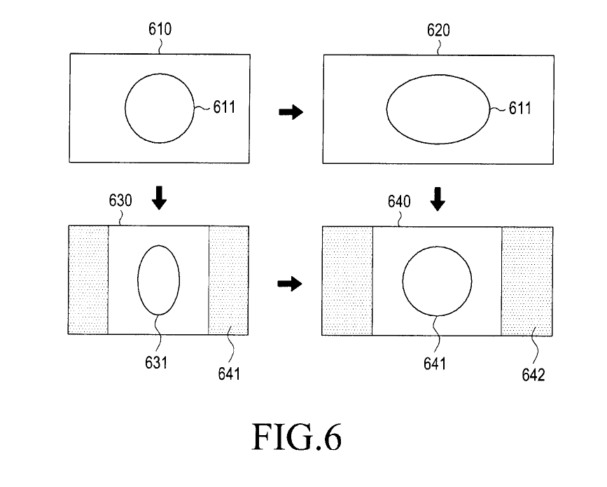

FIG. 5B is a flowchart illustrating a screen configuration method according to various embodiments of the present disclosure. For example, the screen configuration method of FIG. 5B may correspond to a detailed operation of the second image generation operation of FIG. 5A. The screen configuration method of FIG. 5B will be described in more detail with reference to FIG. 6. FIG. 6 illustrates a screen configuration according to various embodiments of the present disclosure.

In operation 531, the electronic device 101 may acquire a horizontal-to-vertical ratio (e.g., aspect ratio) of a first image 610. For example, as illustrated in FIG. 6, the first image 610 may be an image configured to have a size before the stretchable display is stretched. The first image 610 may be an image including a first object 611. According to the embodiment of FIG. 6, the electronic device 101 may acquire a horizontal-to-vertical ratio of the first image 610 corresponding to a1:b1.

In operation 532, the electronic device 101 may acquire a horizontal-to-vertical ratio of the expanded stretchable display. For example, the electronic device 101 may acquire a horizontal-to-vertical ratio of the expanded stretchable display corresponding to a2:b1. Accordingly, when the electronic device 101 displays the first image 610 with no change, the expanded stretchable display may be displayed as indicated reference numeral 620.

In operation 533, the electronic device 101 may determine a horizontal-to-vertical ratio of a second image 630 based on the horizontal-to-vertical ratio of the stretchable display. For example, the electronic device 101 may determine the horizontal-to-vertical ratio of the second image 630 as A1:B1. When the second image 630 is displayed on the expanded stretchable display, the electronic device 101 may determine the horizontal-to-vertical ratio (A1:B1) of the second image 630 to be the same as the horizontal-to-vertical ratio (a1:b1) of the first image 630. According to the embodiment of FIG. 6, the second image 630 may be displayed on the expanded stretchable display at a horizontal-to-vertical ratio of A2:B1. That is, the electronic device 101 may determine the horizontal-to-vertical ratio A1:B1 of the second image 630 to make A2:B1 the same as a1:b1. Meanwhile, it can be noted from FIG. 6 that a1:a2 may be the same A1:A2. Here, a1:a2 is a ratio between the stretchable display before the stretching and the stretchable display after the stretching and may be acquired in the acquired stretch state, and a2/a1 is called k. The electronic device 101 may determine A1 based on equation (1).

$$A 1 = \frac{a 1}{k} \qquad ( 1 )$$

That is, when a stretch ratio in a first direction is k, the electronic device 101 may configure a length of the second image 630 as 1/k of a length of the first image 610 in the first direction. Meanwhile, when the stretchable display two-dimensionally stretches by k times in a first direction and 1 times in a second direction, the electronic device 101 may determine a length of the second image 630 in the first direction as 1/k times of a length of the first image 610 in the first direction and a length of the second image 630 in the second direction as 1/1 times of the first image 610 in the second direction. Accordingly, the actually displayed second image 640 may be displayed to have the same horizontal-to-vertical ratio as that of the first image 630. Further, an object 641 within the second image 640 may be also displayed without distortion.

In operation 534, the electronic device 101 may perform the remaining area processing. For example, when the horizontal-to-vertical ratio (A1:B1) of the second image 630 is determined, remaining areas 641 may appear. The electronic device 101 may process the remaining areas 641 such that a first color is consistently displayed in the remaining areas 641. Meanwhile, according to another embodiment, the electronic device 101 may display a function tool in the remaining areas 641 and it may be easily understood by those skilled in the art that there is no limitation in the processing of the remaining areas 641.

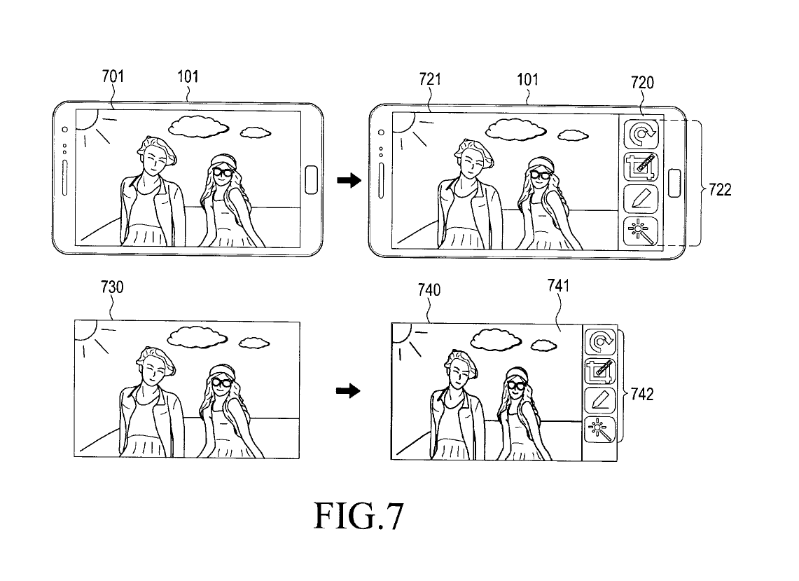

FIG. 7 illustrates screen configurations of the electronic device according to various embodiments of the present disclosure.

The electronic device 101 may display a first image 701 or 730. The electronic device 101 may be expanded to a second size from a first size. In the embodiment of FIG. 7, it is assumed that the electronic device 101 is expanded by k times in one direction (for example, an x-axis direction).

The electronic device 101 may acquire a stretch state of the stretchable display, that is, a stretch ratio corresponding to k times. The electronic device 101 may generate a second image 721 or 741 based on the stretch state. The electronic device 101 may generate the second image 741 having a length in the x-axis direction, which is compressed from the length of the first image 730 in the x-axis direction by 1/k times.

The electronic device 101 may arrange a function tool 742 in the remaining areas. The function tool 742 may be a set of tools having functions for editing the image. Meanwhile, the embodiment in which the function tool 742 is arranged is only an example, and various configurations such as image-related information, a relevant application icon, and the like may be arranged in the remaining areas.

The electronic device 101 may display the second image 721 and a function tool 722 on the expanded stretchable display. Accordingly, the user may view the second image 721 at the same horizontal-to-vertical ratio as that of the first image 710.

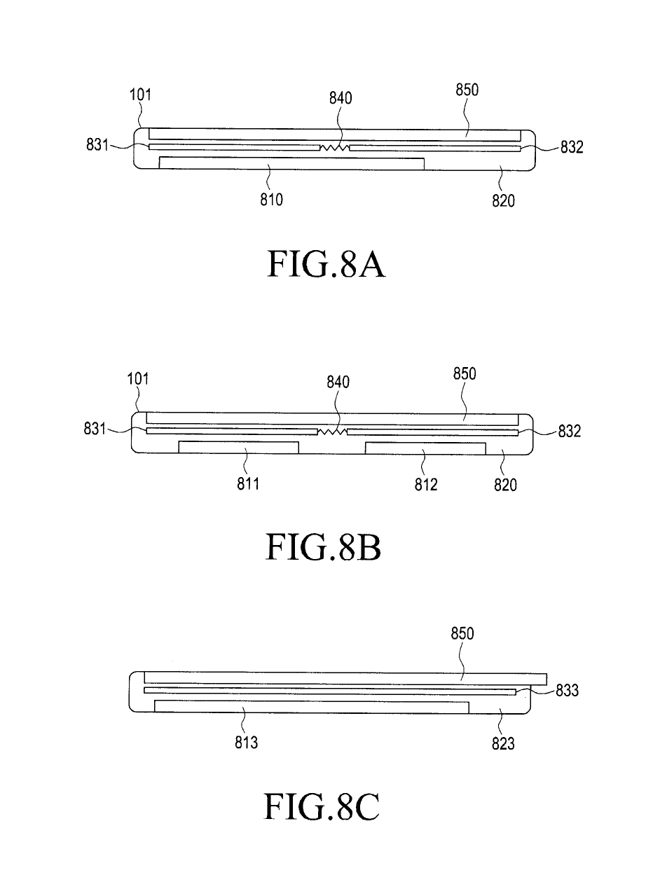

FIGS. 8A to 8C illustrate side views of the electronic device 101 according to various embodiments of the present disclosure.

Referring to FIG. 8A, the electronic device 101 may include a stretchable battery 810, a stretchable body 820, a first PCB 831, a second PCB 832, a connector 840, and a stretchable display 850.

The stretchable battery 810 may include at least one cell and a part connecting the cells may be stretchable. Meanwhile, the first PCB 831 and the second PCB 832 are connected through the connector 840, and thus also are stretchable.

Meanwhile, although not illustrated, the electronic device 101 may include a sensor unit that detects a stretch direction and a stretch level. The stretchable body 820 may include a stretchable material such as rubber or may have a separable configuration.

Referring to FIG. 8B, the electronic device 101 may include a first battery 811, a second battery 812, the stretchable body 820, the first PCB 831, the second PCB 832, the connector 840, and the stretchable display 850.

Even though the first battery 811 and the second battery 812 are not stretchable, the electronic device 101 can stretch overall since the first battery 811 and the second battery 812 are separated from each other.

Referring to FIG. 8C, the electronic device 101 may include a battery 813, a body 823, a PCB 833, and the stretchable display 850. In FIG. 8C, the battery 813, the body 823, and the PCB 833 may not be stretchable. At least a part of the stretchable display 850 may be fixed to the body 820. When the user holds at least a part of the stretchable display 850 to stretch the stretchable display 850, at least a part including the stretchable display 850 may be expanded in a corresponding direction.

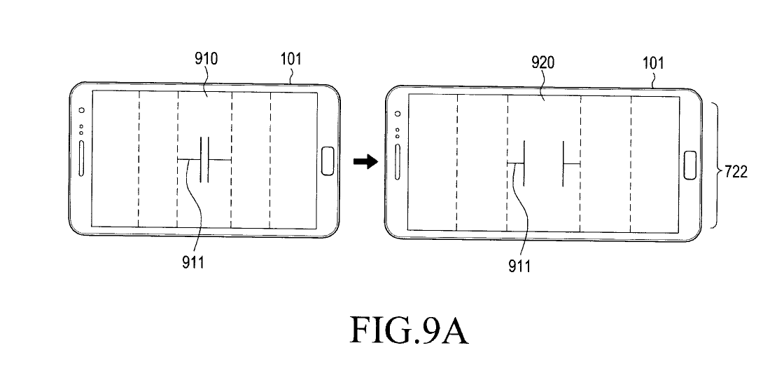

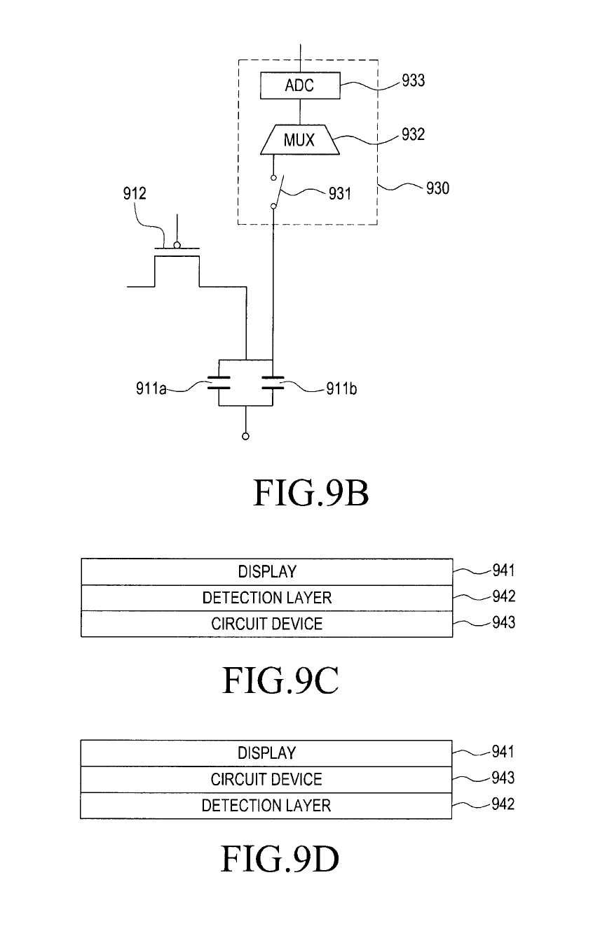

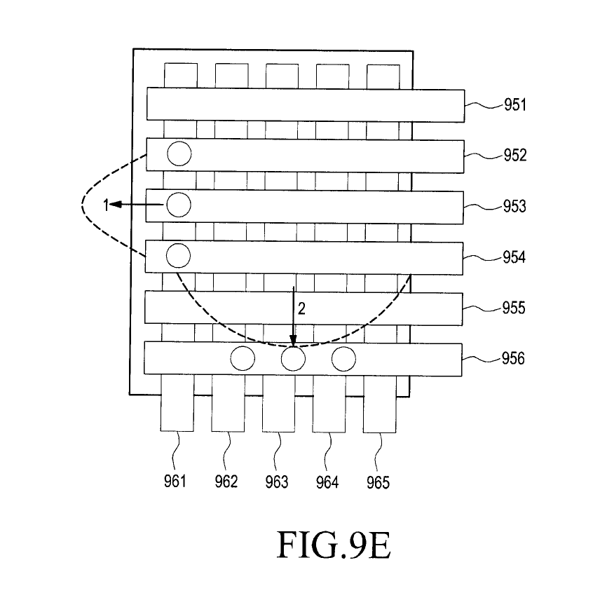

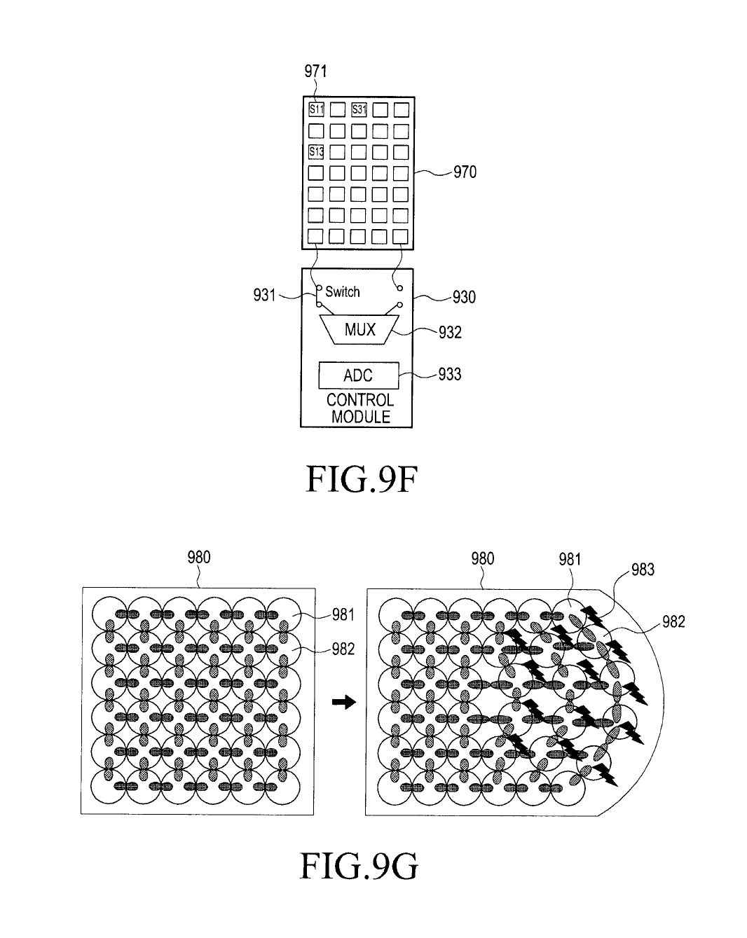

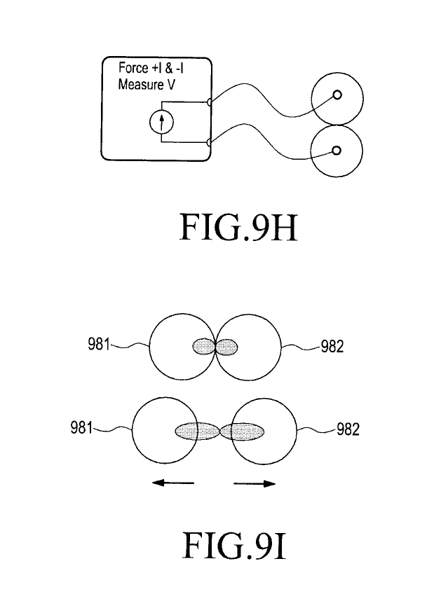

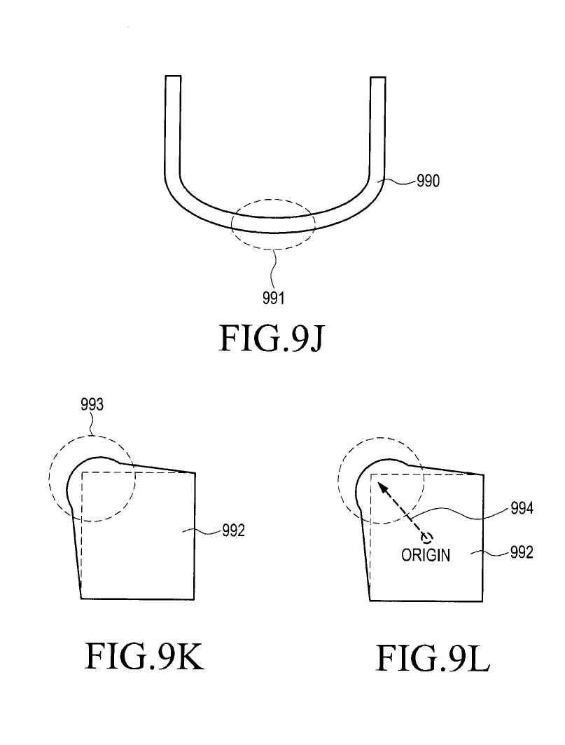

FIGS. 9A to 9L illustrate measurements of a stretch state of the electronic device 101 according to various embodiments of the present disclosure.

Referring to FIG. 9A, the electronic device 101 may include a Touch Screen Panel (TSP) element 910. According to an embodiment, the TSP element 910 may be implemented in a capacitor type. Accordingly, the TSP element 910 may include at least one capacitor 911. At least one capacitor 911 may have capacitance, which is changed by a user's touch, and the electronic device 101 may determine a touch position according to the change in the capacitance.

Meanwhile, according to an embodiment, the entire electronic device 101 may be expanded by an external force. In this case, the capacitor 911 within the TSP element 910 may also be expanded as illustrated in FIG. 9A. The capacitance of the capacitor 911 may be inversely proportional to a distance between two conductors. Accordingly, the electronic device 101 may acquire a stretch state according to the change in the capacitance. More specifically, the electronic device 101 may identify capacitances of each of a plurality of capacitors. The electronic device 101 may identify a stretchable pixel according to the change in the capacitance of the individual capacitor. Further, the electronic device 101 may acquire a stretch direction according to a location of the stretchable pixel. The electronic device 101 may acquire a stretch ratio according to a ratio between the existing capacitance and the capacitance after the change. Accordingly, the electronic device 101 may acquire an area of the stretchable display after the stretching. Further, the electronic device 101 may acquire a stretch level according to a capacitance change rate based on time.

FIG. 9B illustrates a connection of a stretch level measurement element of the electronic device 101 according to various embodiments of the present disclosure.

As illustrated in FIG. 9B, one or more capacitors 911a and 911b and a transistor 912 may be included in each pixel of the display. The first capacitor 911a and the second capacitor 911b may be connected to each other in parallel, and the form thereof may be changed by the stretching. More specifically, when the display is stretched, an interval between conductors of at least one of the first capacitor 911a and the second capacitor 911b within the pixel may be expanded. Accordingly, the capacitance may decrease, and the processor may determine a stretch level and a stretch position according to the change in the capacitance. As illustrated in FIG. 9B, the second capacitor 911b may be connected to a control module 930. The control module 930 may include a switch 931, a MUX 932, and an Analog to Digital Converter (ADC) 933. The switch 931 may determine its on/off state based on a scan period of each pixel. For example, the MUX 932 may be connected to a line corresponding to each pixel, and a pixel to be scanned and the ADC 933 may be connected for the scan period. The ADC 933 may convert information on a current, voltage, or capacitance of the second capacitor 911b into digital information and output the digital information. The processor may grasp capacitance information according to each pixel and detect at least one of a stretch position and a stretch level based on the capacitance information according to each pixel.

FIGS. 9C and 9D depict side views of the electronic device according to various embodiments of the present disclosure. Referring first to FIG. 9C, a detection layer 942 may be formed on a circuit device 943. The display 941 may be formed on the detection layer 942. The detection layer 942 is a layer, which may detect at least one of the stretch level and the stretch position, and will be described below in more detail. According to another embodiment, as illustrated in FIG. 9D, a circuit device 943 may be formed on the detection layer 942 and the display 941 may be formed on the circuit device 943.

FIG. 9E is a conceptual diagram illustrating a detection layer according to various embodiments of the present disclosure. As illustrated in FIG. 9E, the detection layer according to various embodiments of the present disclosure may include one or more linear sensors 951 to 956 and 961 to 965. The linear sensors 951 to 956 and 961 to 965 may include a pressure sensor or a flex sensor. The linear sensors 951 to 956 may expand further in an x-axis direction than a y-axis direction, and may be used for detecting y-axis coordinates of extending points. The linear sensors 961 to 966 may expand further in a y-axis direction than an x-axis direction, and may be used for detecting x-axis coordinates of extending points. For example, a case where the linear sensor 953 is stretched relatively more as illustrated in FIG. 9E is assumed. In this case, the processor may determine that a stretch position is a left side 1 and an extending point corresponds to the linear sensor 953. According to another example, a case where the linear sensor 963 is stretched relatively more as illustrated in FIG. 9E is assumed. In this case, the processor may determine that an extending direction is a lower side 2 and a stretch position corresponds to the linear sensor 963.

FIG. 9F is a conceptual diagram illustrating a detection layer according to various embodiments of the present disclosure. As illustrated in FIG. 9F, a detection layer 970 according to various embodiments of the present disclosure may include at least one planar sensor 971. The planar sensor 910 may include a pressure sensor or a flex sensor.

As illustrated in FIG. 9F, the planar sensor 971 may be connected to the control module 930. The control module 930 may include the switch 931, the MUX 932, and the Analog to Digital Converter (ADC) 933. The switch 931 may determine its on/off state based on a scan period according to each pixel. For example, the MUX 932 may be connected to a line corresponding to each planar sensor 971, and the planar sensor 971 to be scanned and the ADC 933 may be connected for a scan period. The ADC 933 may convert an expansion level or a shrinkage level of the planar sensor 971 into digital data and output the digital data. The processor may detect a stretch level according to each planar sensor 971 to grasp at least one of a stretch position and a stretch level. Particularly, each planar sensor 971 may have an absolute coordinate and the processor may determine a stretch position based on the absolute coordinate.

FIG. 9G is a conceptual diagram illustrating a detection layer according to various embodiments of the present disclosure. The embodiment of FIG. 9G will be described in more detail with reference to FIGS. 9H and 9I. As illustrated in FIG. 9G a detection layer 980 may include a plurality of conductive cells 981 and 982. As illustrated in FIG. 9H, a current may be applied and may flow between the conductive cells 981 and 982. As illustrated in FIG. 9I, the current may flow between the conductive cells 981 and 982 when the conductive cells 981 and 982 contact each other but the current cannot flow when the conductive cells 981 and 982 are separated from each other. As illustrated in FIG. 9G; when the detection layer 980 is expanded, the conductive cells 981 and 982 may be generated to have an opening 983 therebetween. The processor may determine at least one of a stretch position and a stretch level based on whether the opening between the conductive cells is generated.

FIGS. 9J to 9L are conceptual diagrams for describing a method of determining a stretch direction after the determination of the stretch position. As illustrated in FIGS. 9J and 9K, the processor may detect areas 991 and 993 of the detection layers 980 and 982 on which a deformation is concentrated. For example, the processor may detect the areas 991 and 993 on which the deformation is concentrated according to the various methods described in FIGS. 9E to 9I.

As illustrated in FIG. 9L, the processor may determine a direction 994 between the area 993 on which the deformation is concentrated and a preset origin and determine a stretch direction based on the determined direction.

As illustrated in FIG. 9B, separately from the TSP element 910, the sensor unit 940 may be included in the electronic device 101. The sensor unit 940 may include at least one capacitor as illustrated in FIG. 9A.

Meanwhile, a configuration in which the electronic device 101 includes the capacitor and acquires the stretch state based on the measured capacitance has been described in FIGS. 9A and 9B. However, this is only an example, and it may be easily understood by those skilled in the art that a configuration in which the electronic device 101 includes, for example, a resistor and acquires a stretch state based on a measured resistance value may be implemented. Since the resistance value is proportional to a length of a resistor element, the electronic device 101 may also acquire a stretch state according to a change in the resistance value. For example, the electronic device 101 may include an R-type TSP and, in this case, the electronic device 101 may acquire a stretch state based on the measured resistance value. Alternatively, as illustrated in FIG. 9B, the sensor unit 940, which is included in the electronic device separately from the TSP, may include a resistor.

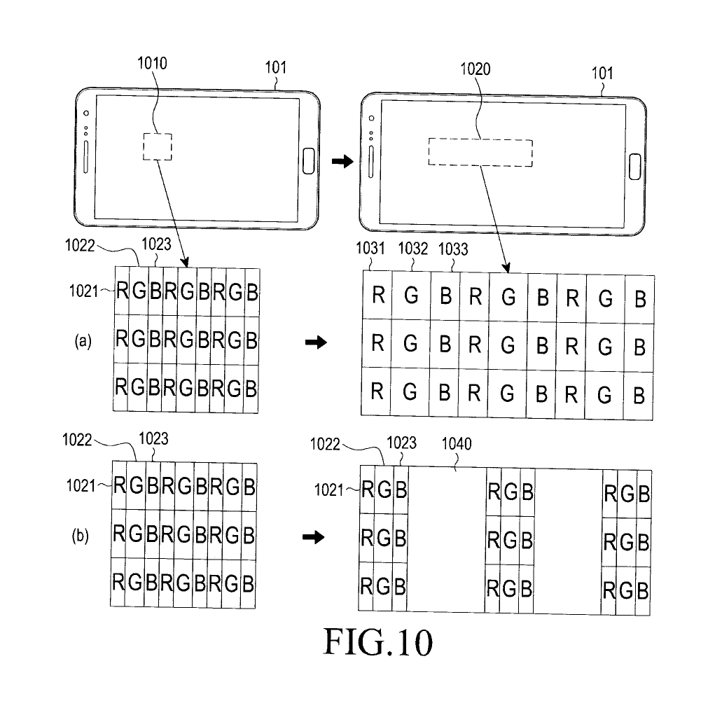

FIGS. 10A and 10B illustrate an expansion of pixels of the electronic device according to various embodiments of the present disclosure.

As illustrated in FIG. 10, the electronic device 101 may be expanded in a first direction (for example, an x-axis direction). Accordingly, a first area 1010 of the stretchable display may also be expanded to be a second area 1020. The first area 1010 may include a plurality of Red (R) pixels 1021, Green (G) pixels 1022, and Blue (B) pixels 1023.

In the embodiment of FIG. 10A, when the first area 1010 is expanded to be the second area 1020, the R pixel 1021, the G pixel 1022, and the B pixel 1023 may be expanded to be a Red (R) pixel 1031, a Green (G) pixel 1032, and a Blue (B) pixel 1033, respectively.

In the embodiment of FIG. 10B, when the first area 1010 is expanded to be the second area 1020 a connection area 1040 may be expanded while the R pixel 1021, the G pixel 1022, and the B pixel 1023 maintain the original size.

As illustrated in FIGS. 10A and 10B, even when the stretchable display is stretched, the same number of pixels may remain and, accordingly, resolutions before and after the stretching may be the same.

Meanwhile, as illustrated in FIG. 10A, when the R pixel 1021, the G pixel 1022, and the B pixel 1023 are expanded to be a Red (R) pixel 1031, a Green (G) pixel 1032, and a Blue (B) pixel 1033, respectively, brightness of lights output from the pixels 1021, 1022, and 1023 may decrease. This is because, when the electronic device 101 applies a voltage before the stretching to each of the pixels 1021, 1022, and 1023, the output light amounts are the same as the previous light amounts. For example, since the light amounts are constant even though areas of the pixels 1021, 1022, and 1023 are expanded, an output speed of light (flux) may decrease. The user recognizes brightness according to the flux, so that the brightness recognized by the user may change before and after the stretching of the stretchable display.

The electronic device 101 may determine voltages applied to the pixels based on the expanded areas of the stretchable display. The electronic device 101 may determine the voltages applied to the pixels to allow the fluxes of the pixels 1021, 1022, and 1023 before and after the expansion to be the same based on the acquired stretch state.

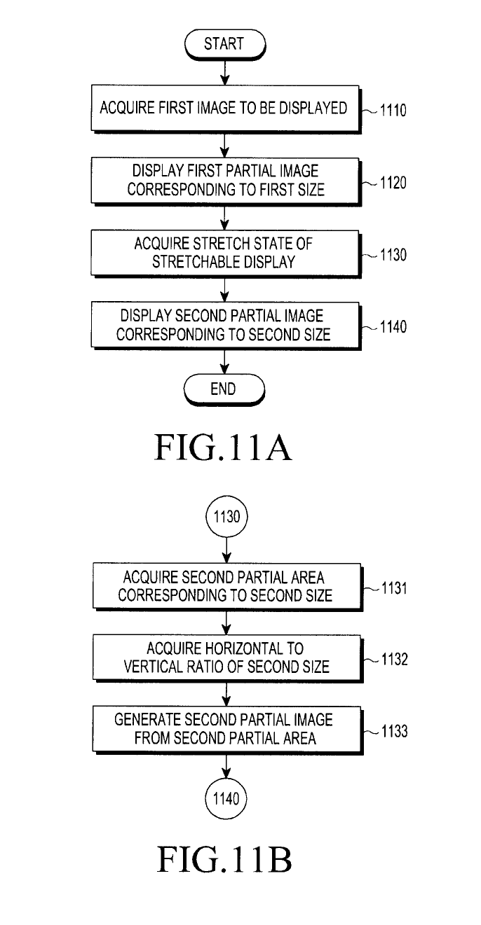

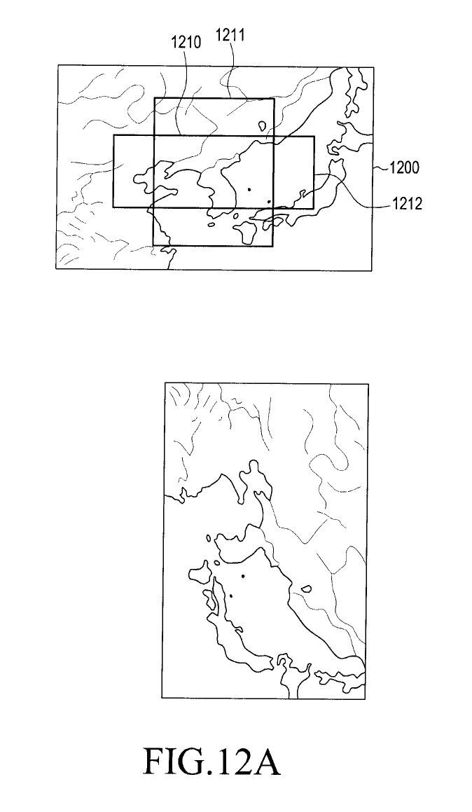

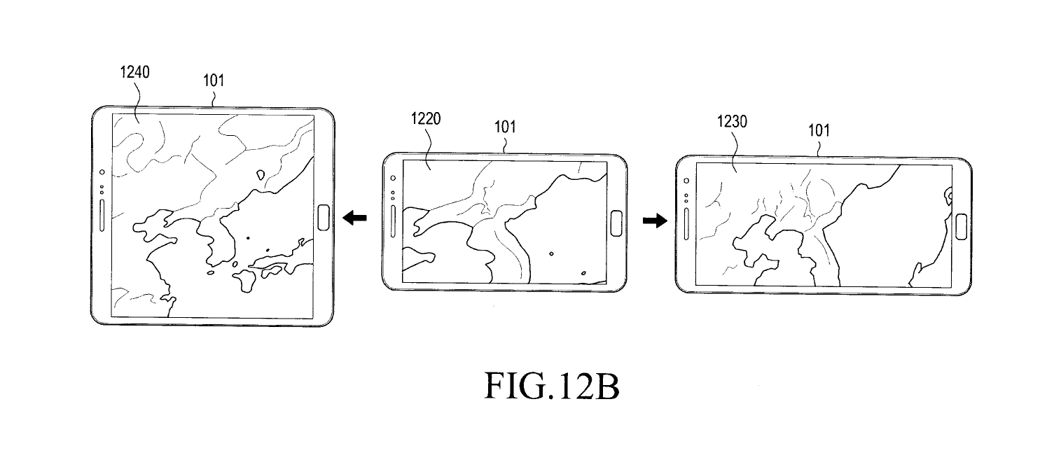

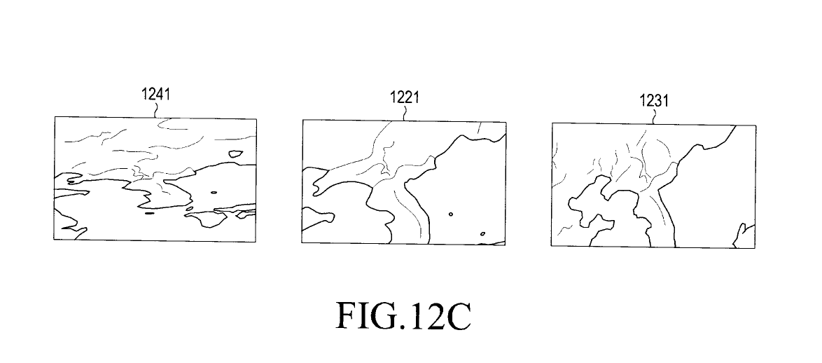

FIG. 11A is a flowchart illustrating a screen configuration method according to various embodiments of the present disclosure. The screen configuration method of FIG. 11A will be described in more detail with reference to FIGS. 12A, 12B, and 12C.

In operation 1110, the electronic device 101 may acquire a first image 1200 to be displayed. The first image 1200 may be an image which can be cropped as illustrated in FIG. 12A. The crop may mean trimming a partial area having a particular size from the entire image. For example, in FIG. 12A, a first partial area 1210 may be cropped from the first image 1200, which is the entire image.

In operation 1120, the electronic device 101 may crop the first partial area 1210 corresponding to a first size of the stretchable display from the first image 1200 and display the cropped first part area 1210. For example, as illustrated in FIG. 12B, the stretchable display of the electronic device 101 at the center may have the first size. The electronic device 101 may display a first partial image 1220 corresponding to the first size. Meanwhile, the first partial image 1220 may correspond to the first partial area 1210 and the image 1221.

In operation 1130, the electronic device 101 may acquire a stretch state of the stretchable display. For example, as illustrated in FIG. 12B, the stretchable display of the left electronic device 101 may be expanded in upwardly and downwardly. The electronic device 101 may identify the size (that is, the second size) and the expansion direction of the stretchable display.

In operation 1140, the electronic device 101 may display a second partial image 1240 corresponding to the second size of the stretchable display. The electronic device may crop a second partial area 1211 based on the acquired expansion direction and size. The second partial image 1240 may correspond to the second partial area 1211. According to the above description, the electronic device 101 may display areas different from the areas of the entire image before the stretching based on the stretch state of the stretchable display.

FIG. 11B is a flowchart illustrating a screen configuration method according to various embodiments of the present disclosure. The screen configuration method of FIG. 11B may be performed, for example, between operation 1130 and operation 1140 of FIG. 11A. The screen configuration method of FIG. 11B will be described in more detail with reference to FIGS. 12A, 12B, and 12C.

In operation 1131, the electronic device 101 may acquire the second partial area 1211 corresponding to the second size of the stretchable display. The electronic device 101 may crop and acquire the second partial area 1211 from the first image 1200 based on the acquired stretch state. The electronic device 101 may acquire the second partial area 1211 based on a stretch direction of the stretchable display. For example, the stretchable display of the left electronic device 101 of FIG. 12B is expanded in up and down directions and the electronic device 101 may acquire such a stretch state. The electronic device 101 may acquire the second partial area 1211 extended from the first partial area 1210 in the up and down directions. The electronic device 101 may acquire the second partial area 1211 with the size corresponding to the second size.

In operation 1132, the electronic device 101 may acquire a horizontal-to-vertical ratio of the second size of the stretchable display.

In operation 1133, the electronic device 101 may generate a second partial image 1241 from the second partial area 1211. The electronic device 101 may determine a horizontal-to-vertical ratio of the second partial area 1241 to allow the second partial image 1240 displayed on the stretchable display to be the same as the second partial area 1211. For example, when the left electronic device 101 of FIG. 12B is expanded by m times in the up and down directions compared to the electronic device 101 before the stretching, the electronic device 101 may determine the horizontal-to-vertical ratio of the second image 1241 such that the second partial area 1211 is compressed by 1/m times in up and down directions. Accordingly, when the electronic device 101 actually displays the second image on the stretchable display, the second image may have the same horizontal-to-vertical ratio as that of the second partial area 1211.

Meanwhile, according to another embodiment, the electronic device 101 may be expanded in left and right directions as illustrated in the right side of FIG. 12B. For example, it is assumed that the electronic device 101 is expanded at a ratio of n times in the left and right directions.

The electronic device 101 may acquire a stretch state and acquire a third partial area 1212 based on the stretch state. The third partial area 1212 is a partial area which further includes left and right areas of the first partial area 1210 and may correspond to the size of the stretched stretchable display.

In an actual display, the electronic device 101 may generate a third image 1231 to have the same horizontal-to-vertical ratio as that of the third partial area 1212. For example, the electronic device 101 may generate the third image 1231 by compressing the third partial area 1212 by 1/n times in the left and right directions.

The displayed third image 1230 may have the same horizontal-to-vertical ratio as that of the third partial area as illustrated in FIG. 12B.

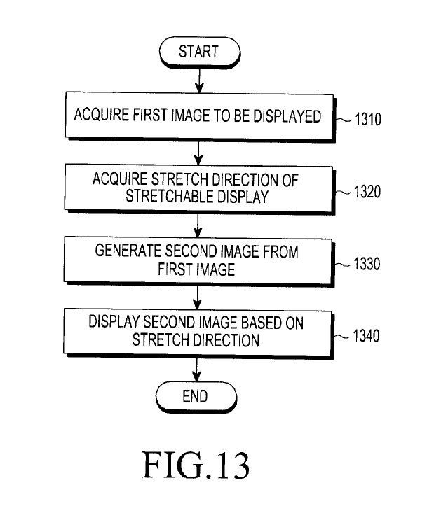

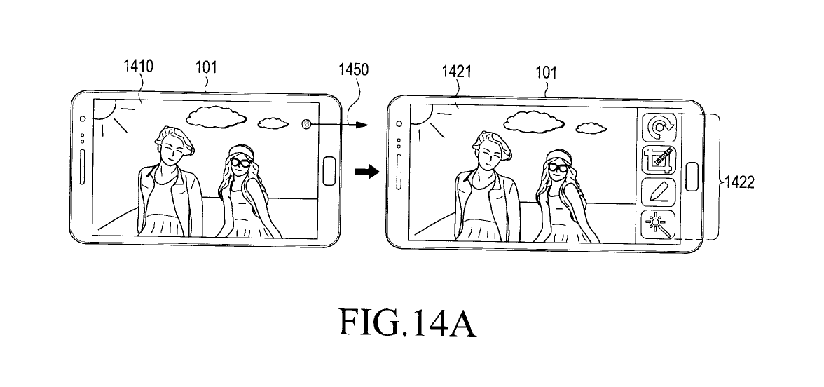

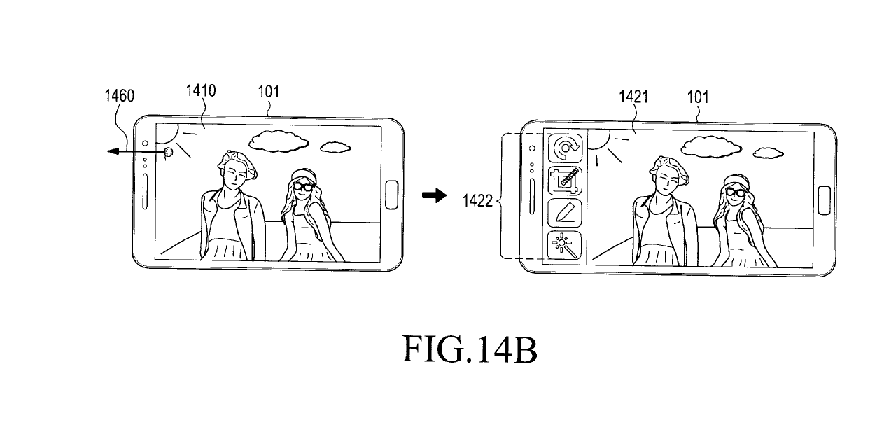

FIG. 13 is a flowchart illustrating a screen configuration method according to various embodiments of the present disclosure. The screen configuration method of FIG. 13 will be described in more detail with reference to FIGS. 14A and 14B.

In operation 1310, the electronic device 101 may acquire a first image 1410 to be displayed.

In operation 1320, the electronic device 101 may acquire a stretch direction of the stretchable display. For example, in the embodiment of FIG. 14A, the electronic device 101 is expanded in a right direction 1450. The electronic device 101 may acquire the stretch direction by identifying a position where the user touches. For example, when the stretchable display is expanded in a state where the user touches the relatively right side of the stretchable display, the electronic device 101 may determine that the stretch direction is the right side. According to another embodiment, the electronic device 101 may acquire the stretch direction based on data obtained from the sensor unit.

In operation 1330, the electronic device 101 may generate a second image 1421 from the first image 1410 based on the stretch state. As described above, the electronic device 101 may generate the second image 1421 such that the actually displayed second image 1421 has the same horizontal-to-vertical ratio as that of the first image 1410.

In operation 1340, the electronic device 101 may display the second image 1421 based on the stretch direction. For example, the electronic device 101 may arrange the second image 1421 on the relatively left side of the stretchable display and display the remaining areas on the relatively right side. In the embodiment of FIG. 14A, the electronic device 101 may display a function tool 1422 in the remaining areas. Accordingly, when the user expands the stretchable display in the right direction, a UX, which shows as if the function tool 1422 is provided on the right side of the second image 1421, may be provided.

Meanwhile, in FIG. 14B, the stretchable display may be expanded in a left direction 1460. The electronic device 101 may display the second image 1421 based on the stretch direction. For example, the electronic device 101 may arrange the second image 1421 on the relatively right side of the stretchable display and display the remaining areas on the relatively left side. Accordingly, when the user expands the stretchable display in the left direction, a UX, which shows as if the function tool 1422 is provided on the left side of the second image 1421, may be provided.

As described above, the electronic device 101 according to various embodiments of the present disclosure may establish the screen configuration based on the stretch direction.

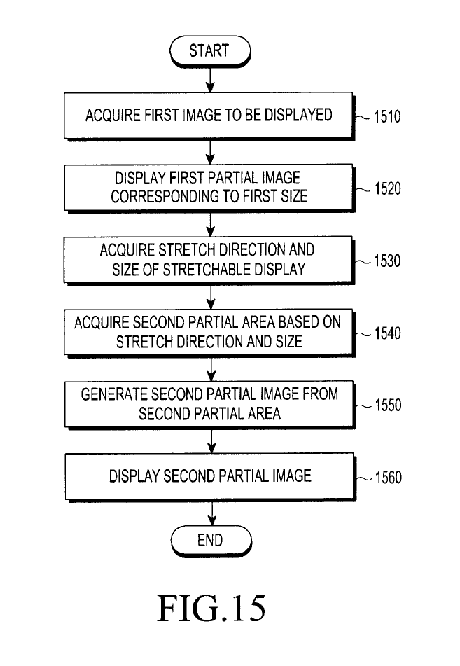

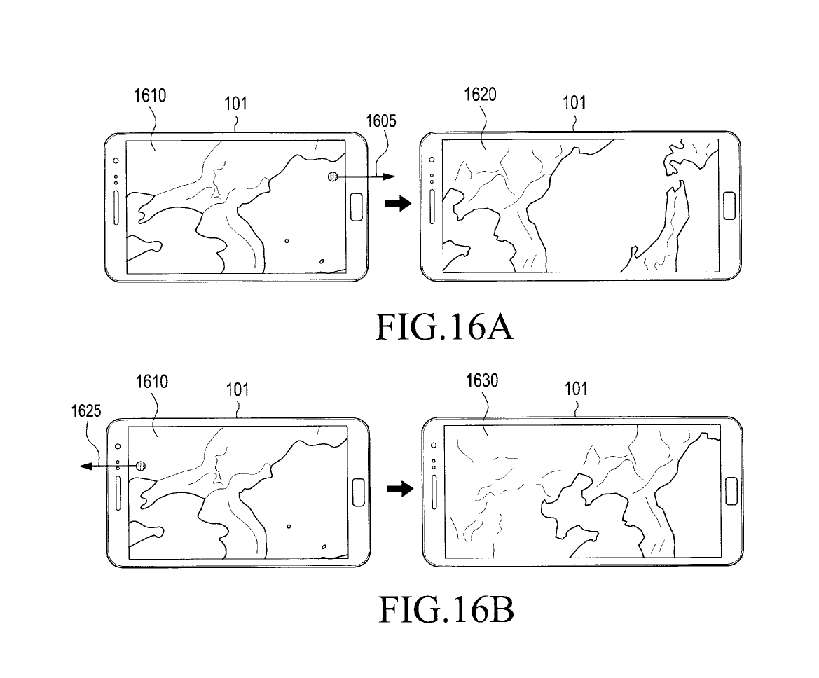

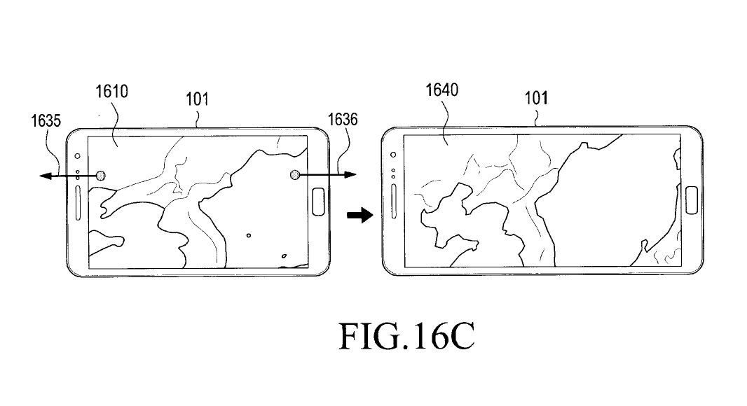

FIG. 15 is a flowchart illustrating a screen configuration method according to various embodiments of the present disclosure. The screen configuration method of FIG. 15 will be described in more detail with reference to FIGS. 16A to 16C. Meanwhile, a first image of FIG. 15 may be, for example, the first image 1210 of FIG. 12, that is, the entire image, which can be cropped.

In operation 1510, the electronic device 101 may acquire the first image to be displayed, for example, a base image, which can be cropped.

In operation 1520, the electronic device 101 may crop a first partial image 1610 from the base image, which corresponds to a first size of the stretchable display from the first image 1200 and display the cropped first partial image 1610. For example, as illustrated in FIGS. 16A to 16C, the stretchable display of the electronic device 101 may have the first size. The electronic device 101 may acquire a first partial area corresponding to the first size and display the first partial image 1610 corresponding to the first partial area.

In operation 1530, the electronic device 101 may acquire a stretch direction and the size of the stretchable display. For example, as illustrated in FIG. 16A, the electronic device 101 may acquire (e.g., detect) the expanding of the stretchable display in a right direction 1605 to have a second size. Alternatively, as illustrated in FIG. 16B, the electronic device 101 may acquire (e.g., detect) the expanding of the stretchable display in a left direction 1625 to have the second size. As illustrated in FIG. 16C, the electronic device 101 may acquire (e.g., detect) the expanding of the stretchable display in both the left and right directions 1635 and 1636 to have the second size. Further, the electronic device 101 may acquire the size corresponding to the second size after the stretching as illustrated in FIGS. 16A to 16C.

In operation 1540, the electronic device 101 may acquire a second partial area based on the stretch direction and size. For example, as illustrated in FIG. 16A, when the stretchable display is expanded in the right direction, the electronic device 101 may determine that the second partial area includes the first partial area and a right area of the first partial area. Further, the electronic device 101 may determine that the size of the second partial area corresponds to the second size. As illustrated in FIG. 16B, when the stretchable display is expanded in the left direction, the electronic device 101 may determine that the second partial area includes the first partial area and a left area of the first partial area. The electronic device 101 may determine that the size of the second partial area corresponds to the second size. As illustrated in FIG. 16C, when the stretchable display is expanded in the left and right directions, the electronic device 101 may determine that the second partial area includes the first partial area, and the left area and the right area of the first partial area. The electronic device 101 may determine that the size of the second partial area corresponds to the second size.

In operation 1550, the electronic device 101 may generate second partial images 1620, 1630, and 1640 from the second partial area. When the second partial images 1620, 1630, and 1640 are displayed, the electronic device 101 may generate the second partial images 1620, 1630, and 1640 from the second partial area to have the same horizontal-to-vertical ratio as that of the second partial area.

In operation 1560, the electronic device 101 may display the second partial images 1620, 1630, and 1640.

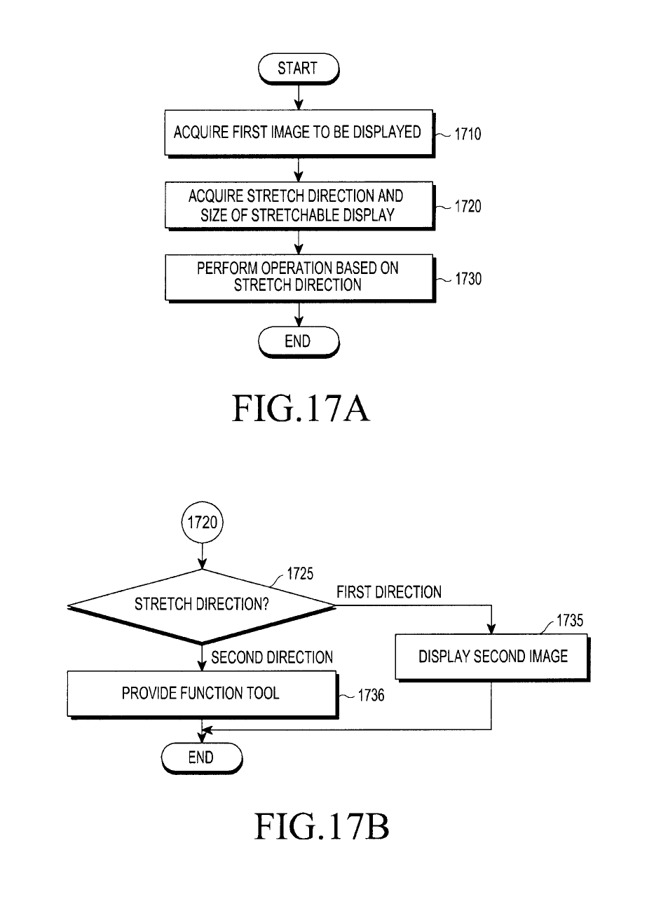

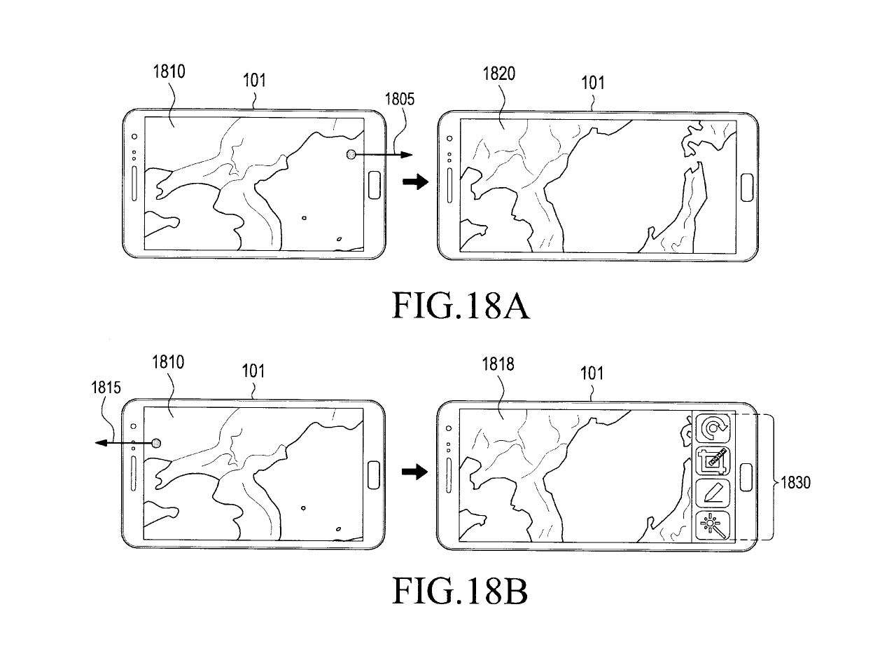

FIG. 17A is a flowchart illustrating a screen configuration method according to various embodiments of the present disclosure. The screen configuration method of FIG. 17A will be described in more detail with reference to FIGS. 18A and 18B. Meanwhile, a first image of FIG. 17A may be, for example, the first image 1210 of FIG. 12 which can be cropped from the base image 1200, as shown.

In operation 1710, the electronic device 101 may acquire a first image 1210 to be displayed. Further, the electronic device 101 may display a first partial image 1810 corresponding to the first partial area of the first image 1210.

In operation 1720, the electronic device 101 may acquire a stretch direction and the size of the stretchable display. For example, the electronic device 101 may acquire the expanding of the stretchable display in a right direction 1805 as illustrated in FIG. 18A. According to another example, the electronic device 101 may acquire the expanding of the stretchable display in a left direction 1815 as illustrated in FIG. 18B. Further, the electronic device 101 may acquire the size of the stretchable display corresponding to the second size after the stretching as illustrated in FIGS. 18A and 18B.

In operation 1730, the electronic device 101 may perform an operation that is selected based on the stretch direction.

FIG. 17B is a flowchart illustrating an operation based on a stretch direction of the electronic device according to various embodiments of the present disclosure. The operation of FIG. 17B may be performed after, for example, operation 1720 of FIG. 17A.

In operation 1725, the electronic device 101 may determine whether the stretch direction is a first direction or a second direction. For example, in the embodiment of FIGS. 18A and 18B, the electronic device 101 may determine whether the stretch direction is a left direction or a right direction.

When it is determined that the stretch direction is the first direction, the electronic device 101 may display a second image 1820 in operation 1735 as illustrated in FIG. 18A. The second image 1820 may be an image generated in accordance with the second partial area cropped from the first image 1200 (e.g., base image). Meanwhile, when the second image 1820 is displayed, the second image 1820 may be generated to have the same horizontal-to-vertical ratio as that of the second partial area. That is, the electronic device 101 may display an image corresponding to the expanded cropped area in accordance with the stretching in the first direction.

When it is determined that the stretch direction is the second direction, the electronic device 101 may display a function tool 1830 in operation 1736 as illustrated in FIG. 18B. Further, the electronic device 101 may display a second image 1818 to have the same horizontal-to-vertical ratio as that of the first partial image 1810.

As described above, the electronic device 101 may perform different operations according to the acquired stretch directions.

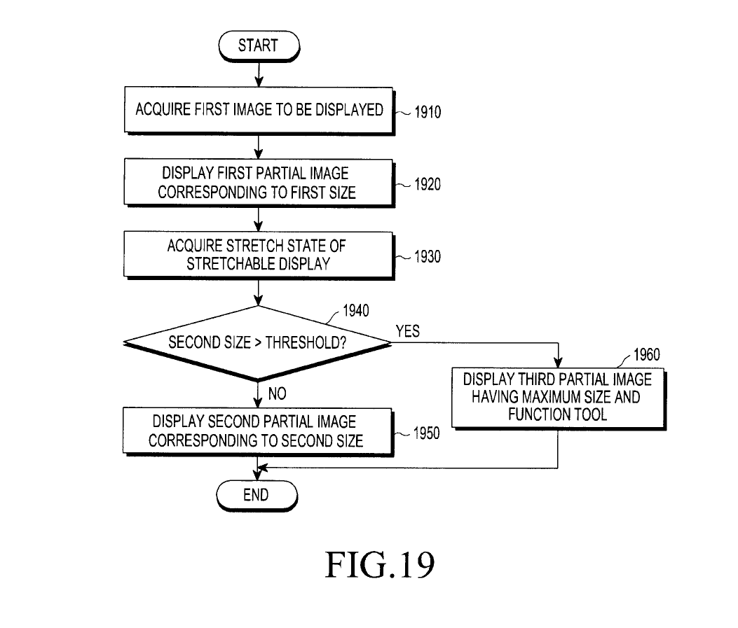

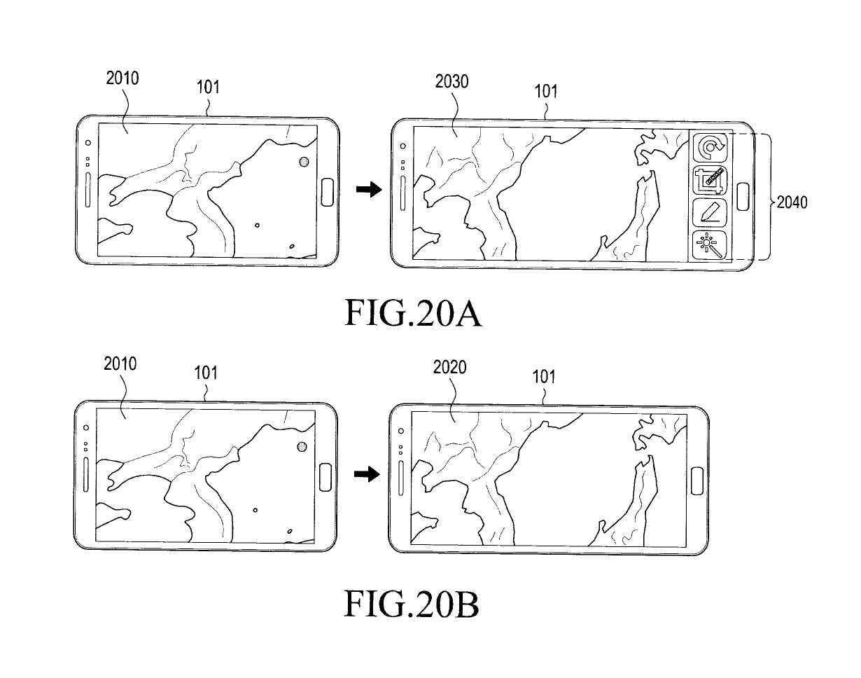

FIG. 19 is a flowchart illustrating a screen configuration method according to various embodiments of the present disclosure. The screen configuration method of FIG. 19 will be described in more detail with reference to FIGS. 20A and 20B. Meanwhile, a first image of FIG. 19 may be, for example, the first image 1210 of FIG. 12, that is, the entire image, which can be cropped.

In operation 1910, the electronic device 101 may acquire the first image to be displayed.

In operation 1920, the electronic device 202 may crop a first partial area corresponding to a first size, which is the size of the stretchable display before the stretching, from the first image. The electronic device 101 may display a first partial image 2010 corresponding to the first partial area.

In operation 1930, the electronic device 101 may acquire a stretch state of the stretchable display. For example, the electronic device 101 may acquire the expanding of the stretchable display in left and right directions as illustrated in FIG. 20A. The electronic device 101 may acquire a second size corresponding to the size of the stretchable display after the stretching.

In operation 1940, the electronic device 101 may determine whether the second size of the stretchable display is larger than a threshold. The threshold may be preset to the electronic device 101.

When it is determined that the second size is equal to or smaller than the threshold, the electronic device 101 may display a second partial area 2020 corresponding to a second size in operation 1950 as illustrated in FIG. 20A. The electronic device 101 may crop and acquire a second partial area corresponding to the second size from the first image 1200. The electronic device 101 may generate a second partial image 2020 corresponding to the second partial area. When the second partial image 2020 is displayed, the electronic device 101 may generate the second partial image 2020 to have the same horizontal-to-vertical ratio as that of the second partial area.

When it is determined that the second size is larger than the threshold, the electronic device 101 may display a third partial image 2030 having a maximum size, which can be cropped, and a function tool 2040 in operation 1960 as illustrated in FIG. 20B. The third partial image 2030 may be an image corresponding to a third partial area having the maximum size, which can be cropped. That is, when a predetermined condition is satisfied (e.g., when there is no partial area to be cropped anymore), the electronic device 101 may display the function tool 2040, which is not the cropped image, on the additionally stretched stretchable display. The function tool 2040 is only an example, and it may be easily understood by those skilled in the art that the function tool 2040 can be replaced with and implemented by another configuration.

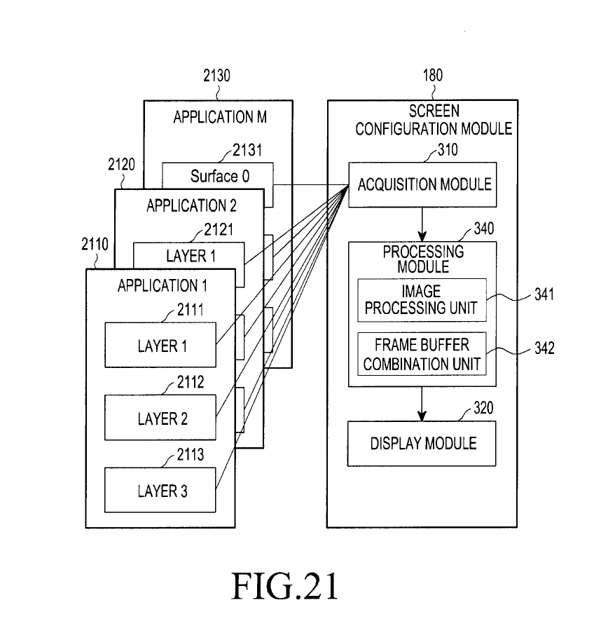

FIG. 21 is a block diagram illustrating a screen configuration process according to various embodiments of the present disclosure.

The screen configuration module 180 may combine layers 2111 to 2113, 2121, and 2131 received from a plurality of user applications 2110 to 2130 into one image and display the one image. More specifically, the acquisition module 310 may receive the layers 2111 to 2113, 2121, and 2131 and output the layers 2111 to 2113, 2121, and 2131 to the processing module 340. The processing module 340 may combine the acquired layers 2111 to 2113, 2121, and 2131 by an image processing unit 341, and output the layers to a frame buffer combination unit 342.

Each of the applications 2110 to 2130 may include one or more layers 2111 to 2113, 2121, and 2131. For example, when the application 2110 is a web browser, which reproduces a dynamic image, the web browser may have the type of ARGB_8888 and the dynamic image may have the type of RGB_565.

The processing module 340 may perform the combination to make an actually displayed image have, for example, the same horizontal-to-vertical ratio as that of the image before the stretching. The combined image may be output to a frame buffer.

The frame buffer 342 may be defined in the kernel and the buffered image may be displayed on the display module 320 via a driver.

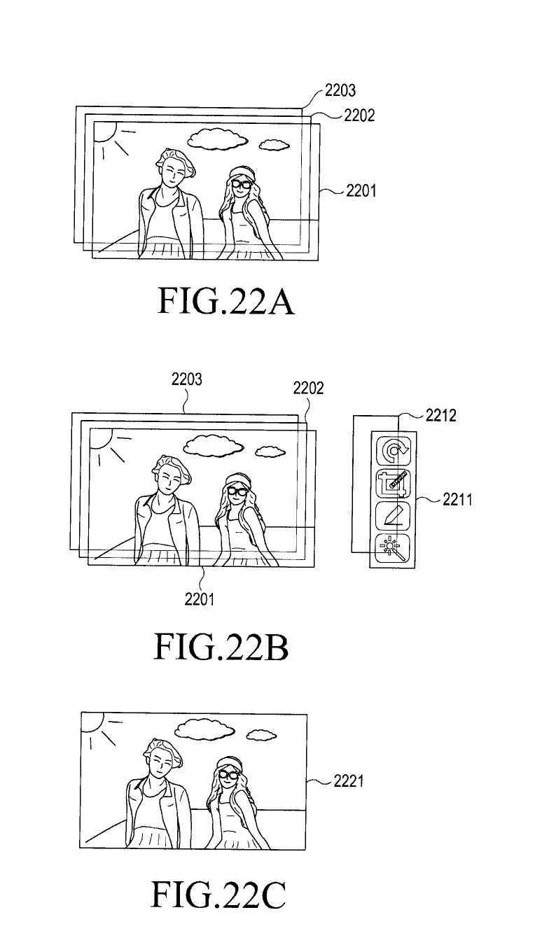

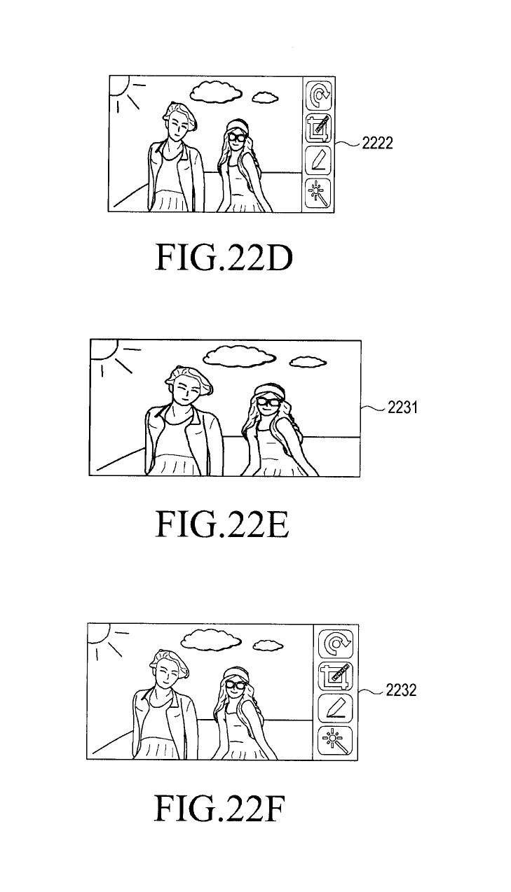

FIGS. 22A and 22B illustrate a layer configuration according to various embodiments of the present disclosure.

FIG. 22A may illustrate a process including three layers 2201 to 2203 before the stretching of the stretchable display. The lowest layer 2201 may be a layer corresponding to a layout of the entire screen, the next highest layer 2202 may be an image-related layer, and the highest layer 2203 may be character string-related layer.

FIG. 22B may illustrate a process including two layers 2211 and 2212 in addition to the three layers 2201 to 2203 after the stretching of the stretchable display. The additional two layers 2211 and 2212 may be a layer corresponding to a layout and a function tool-related layer.

FIGS. 22C and 22D illustrate a frame buffer according to various embodiments of the present disclosure.

FIG. 22C illustrates a frame buffer 2221 before the stretching of the stretchable display. The frame buffer 2221 may be a result of a combination of the three layers 2201 to 2203.

FIG. 22D illustrates a frame buffer 2222 after the stretching of the stretchable display and may be a result of a combination of the five layers 2201 to 2203, 2211, and 2212. The frame buffer 2222 of FIG. 22D may be compressed in left and right directions compared to the frame buffer of FIG. 22C.

FIGS. 22E and 22F illustrate images displayed on the stretchable display according to various embodiments of the present disclosure.

FIG. 22E may be an image 2231, which is output from the frame buffer 2221 and actually displayed on the stretchable display. FIG. 22F may be an image 2232, which is output from the frame buffer 2222 and actually displayed on the stretchable display.

Meanwhile, the screen configuration method according to various embodiments of the present disclosure may use a pixel rendering scheme. A basic unit of the rendering is a pixel in the pixel rendering, but a basic unit of the rendering may be a sub pixel in the sub pixel rendering. The sub pixel rendering may be a rendering scheme, which considers a plurality of sub pixels consisting of one pixel as one unit. Actually, pixel geometry of the display may be various, so that the rendering may be used in consideration of the various pixel geometries.

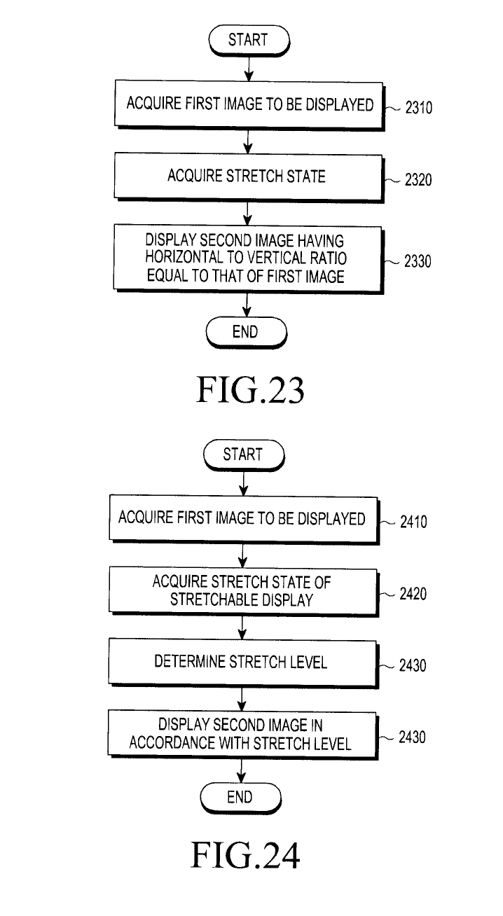

FIG. 23 is a flowchart illustrating a screen configuration method according to various embodiments of the present disclosure.

In operation 2310, the electronic device 101 may acquire a first image to be displayed.

In operation 2320, the electronic device 101 may acquire a stretch state of the stretchable display. For example, the electronic device 101 may acquire a size after the stretching of the stretchable display. In the embodiment of FIG. 23, a case where the stretchable display is expanded in two directions (for example, x and y directions) is assumed.

In operation 2230, when actually displaying the second image, the electronic device 101 may generate and display the second image to have the same horizontal-to-vertical ratio as that of the first image. The electronic device 101 may determine a size of the second image such that a length of at least one direction of the second image is the same as a length of the other direction of the stretched stretchable display

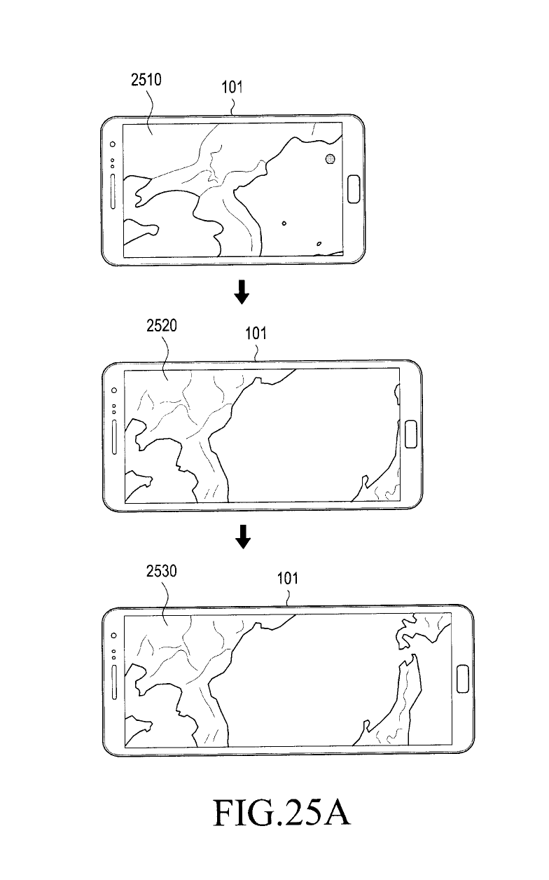

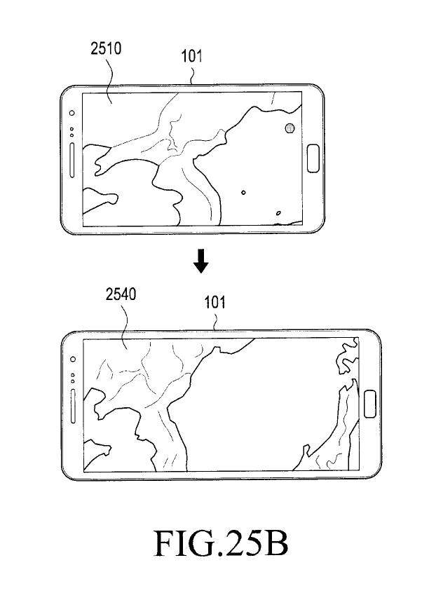

FIG. 24 is a flowchart illustrating a screen configuration method according to various embodiments of the present disclosure. The screen configuration method of FIG. 24 will be described in more detail with reference to FIGS. 25A and 25B. FIGS. 25A and 25B illustrate a screen configuration of the electronic device 101 according to various embodiments of the present disclosure. Meanwhile, a first image of FIG. 24 may be, for example, the first image 1210 of FIG. 12, that is, the entire image, which can be cropped.

In operation 2410, the electronic device 101 may acquire a first image 1210 to be displayed. As illustrated in FIGS. 25A and 25B, the electronic device 101 may display a first partial image 2510. The first partial image 2510 may be a partial image corresponding to the first partial area of the first image 1210.

In operation 2420, the electronic device 101 may acquire a stretch state of the stretchable display. In operation 2430, the electronic device 101 may determine a stretch level of the stretchable display. In some implementations, the stretch level may indicate the extent to which the stretchable display is stretched at a given time. In operation 2440, the electronic device 101 may display a second image in accordance with the stretch level. For example, in FIG. 25A, the stretchable display may be expanded by a first stretch level from a first time point t1 to a second time point t2. In FIG. 25B, the stretchable display may be expanded by a second stretch level from the first time point t1 to a third time point t3. The third time point t3 may be a time point earlier than the second time point t2 and, accordingly, a case where the second stretch level is larger than the first stretch level is assumed.

In FIG. 25A, the electronic device 101 may display a second image 2520 corresponding to the first stretch level. In FIG. 25B, the electronic device 101 may display a third image 2540 corresponding to the second stretch level. The third image 2540 may correspond to a wider partial area in the first image 1200 compared to the second image 2520.

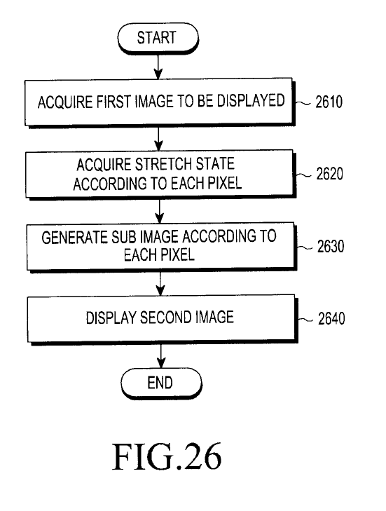

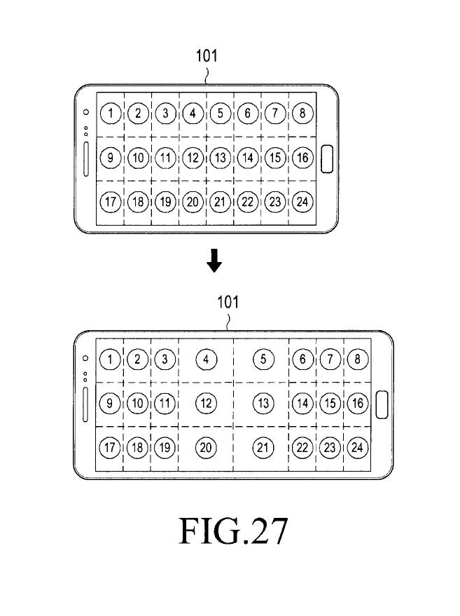

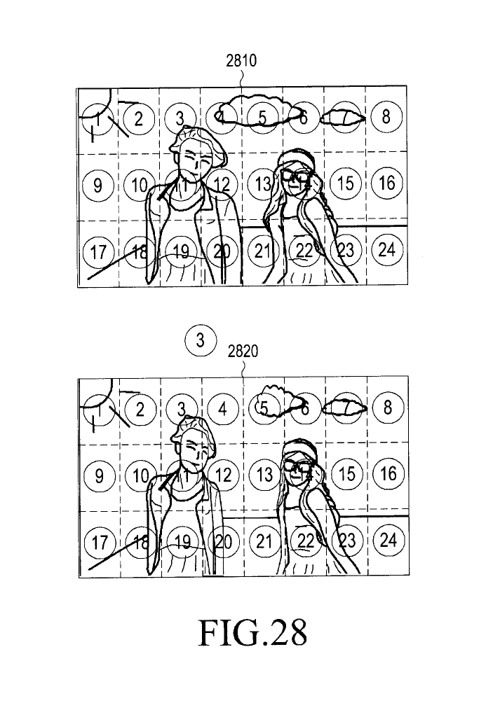

FIG. 26 is a flowchart illustrating a screen configuration method according to various embodiments of the present disclosure. The screen configuration method of FIG. 26 will be described in more detail with reference to FIGS. 27 and 28. FIG. 27 illustrates an expansion of a tile, and FIG. 28 illustrates a second image when the tile of FIG. 27 is expanded.

In operation 2610, the electronic device 101 may acquire a first image to be displayed. For example, the electronic device 101 may acquire a first image 2810 of FIG. 28.

In operation 2620, the electronic device 101 may acquire a stretch state according to each tile. For example, as illustrated in FIG. 27, the electronic device 101 may acquire expansions of a fourth tile, a fifth file, a twelfth tile, a thirteenth tile, a twentieth tile, and a twenty-first tile. In the embodiment of FIG. 27, it is assumed that the fourth tile, the fifth tile, the twelfth tile, the thirteenth tile, the twentieth tile, and the twenty-first tile are not stretched. Further, it is assumed that the fourth tile, the fifth tile, the twelfth tile, the thirteenth tile, the twentieth tile, and the twenty-first tile are expanded by p times in an x-axis direction.

In operation 2630, the electronic device 101 may generate a sub image according to each tile. The electronic device 101 may generate sub images corresponding to the fourth tile, the fifth tile, the twelfth tile, the thirteenth tile, the twentieth tile, and the twenty-first tile. When the fourth tile, the fifth tile, the twelfth tile, the thirteenth tile, the twentieth tile, and the twenty-first tile are actually displayed, the electronic device 101 may generate the sub image according to each tile to have the same horizontal-to-vertical ratio as that of the fourth tile, the fifth tile, the twelfth tile, the thirteenth tile, the twentieth tile, and the twenty-first tile of the first image 2810. For example, as illustrated in FIG. 28, the electronic device 101 may generate a second image 2820 such that the images of the fourth tile, the fifth tile, the twelfth tile, the thirteenth tile, the twentieth tile, and the twenty-first tile become 1/p times of the first image 2810 in the x-axis direction. The electronic device 101 may generate the sub images of the thirteenth tile and the twenty-first tile.

In operation 2640, the electronic device 101 may display the generated second image 2820.

Meanwhile, according to various embodiments, the stretchable display may have different stretch levels according to the tiles. In this case, the stretchable display may generate the sub images according to the tiles in accordance with the different stretch levels.

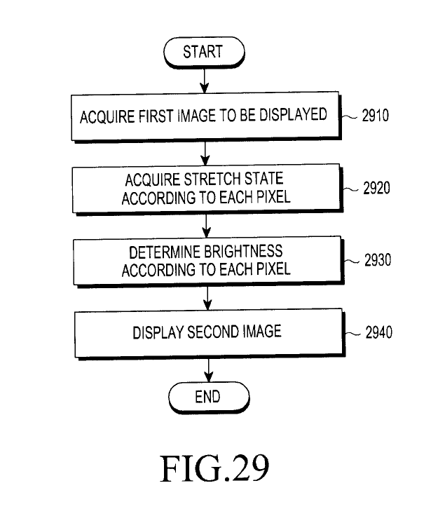

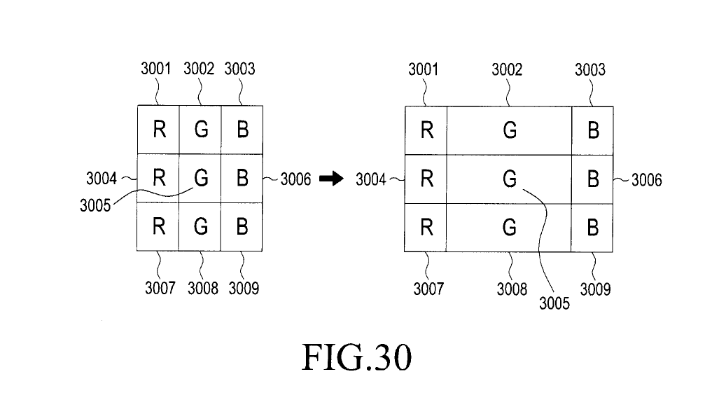

FIG. 29 is a flowchart illustrating a screen configuration method according to various embodiments of the present disclosure. The screen configuration method of FIG. 29 will be described in more detail with reference to FIG. 30. FIG. 30 illustrates a configuration of RGB pixels according to various embodiments of the present disclosure.

In operation 2910, the electronic device 101 may acquire a first image to be displayed.

In operation 2920, the electronic device 101 may acquire a stretch state according to each pixel. For example, in the embodiment of FIG. 30, it is assumed that a second pixel 3002, a fifth pixel 3005, and an eighth pixel 3008 among first to ninth pixels 3001 to 3009 are expanded by r times in an x-axis direction. The electronic device 101 may acquire stretch ratios of the second pixel 3002, the fifth pixel 3005, and the eighth pixel 3008.

In operation 2930, the electronic device 101 may determine a brightness of each pixel. As described above, in order to make a display brightness the same before and after the stretching, amounts of light output from the second pixel 3002, the fifth pixel 3005, and the eighth pixel 3008 should be increased by r times and thus the flux may be uniformly maintained. However, as the amount of light produced by the green pixels increases, mixed colors may become different from the colors before the stretching. Accordingly, the electronic device 101 may determine brightness of the first to ninth pixels 3001 to 3009 such that mixed colors of the RGB pixels after the stretching are the same as the colors before the stretching.

In operation 2940, the electronic device 101 may display a second image based on the determined brightness of each pixel.

According to various embodiments of the present disclosure, a method of configuring a screen by an electronic device may include: an operation of acquiring a first image; an operation of acquiring a stretch state of a stretchable display; an operation of generating a second image by using the first image based on the acquired stretch state; and an operation of displaying the generated second image.

According to various embodiments of the present disclosure, the operation of generating the second image may include, when the second image is displayed on the stretchable display, an operation of determining a horizontal-to-vertical ratio of the second image to be equal to a horizontal-to-vertical ratio of the first image.

According to various embodiments of the present disclosure, the operation of acquiring the stretch state may include an operation of acquiring a stretch ratio of the stretchable display.

According to various embodiments of the present disclosure, the operation of generating the second image may include an operation of determining the horizontal-to-vertical ratio of the second image based on the stretch ratio.

According to various embodiments of the present disclosure, the operation of generating the second image may include an operation of generating the second image by compressing the first image by a reciprocal number of the stretch ratio.

According to various embodiments of the present disclosure, the method of configuring the screen may further include an operation of acquiring the first image corresponding to a first partial area cropped from an entire image.

According to various embodiments of the present disclosure, the method of configuring the screen may further include an operation of cropping a second partial area from the entire image based on the acquired stretch state, and the second image may be an image corresponding to the second partial area.

According to various embodiments of the present disclosure, the operation of acquiring the stretch state may include an operation of acquiring least one of a stretch direction of the stretchable display and a size of the stretchable display and the operation of cropping the second partial area may include an operation of cropping the second partial area in accordance with at least one of the stretch direction and the size.

According to various embodiments of the present disclosure, the operation of displaying the second image may include, when there is no data to be additionally cropped in the entire image, an operation of displaying the second image having a maximum size, which can be cropped.

According to various embodiments of the present disclosure, the operation of acquiring the stretch state may include an operation of acquiring a stretch direction of the stretchable display, and the operation of displaying the second image may include an operation of displaying the second image at a location corresponding to the stretch direction.

According to various embodiments of the present disclosure, the operation of acquiring the stretch state may include an operation of acquiring a stretch level of the stretchable display, and the operation of displaying the second image may include an operation of displaying the second image based on the stretch level.

According to various embodiments of the present disclosure, the operation of displaying the second image may include an operation of acquiring a display brightness of the second image based on the stretch state and displaying the second image with the acquired brightness.

According to various embodiments of the present disclosure, the operation of acquiring a stretch level according to each tile of the stretchable display, and an operation of generating the second image may include an operation of generating the sub image according to each tile based on the stretch state.

According to various embodiments of the present disclosure, the operation of generating the sub image according to each tile may include an operation of generating the sub image according to each tile.

According to various embodiments of the present disclosure, the operation of displaying the second image may include an operation of displaying at least one of a black screen, a function tool, second image-related information, and a second image-related application in remaining areas except for an area of the stretchable display in which the second image is displayed.

According to various embodiments of the present disclosure, a method of configuring a screen of a stretchable display may include: an operation of displaying a first image in accordance with a first size of the stretchable display; and an operation of displaying a second image corresponding to a second size at a horizontal-to-vertical ratio equal to that of the first image in accordance with a stretching of the stretchable display from the first size to the second size.

According to various embodiments of the present disclosure, an electronic device including a stretchable display may include: a sensor module that acquires a stretch state of the stretchable display; a processor that acquires a first image and generates a second image by using the first image based on the acquired stretch state; and the stretchable display that displays the generated second image.

According to various embodiments of the present disclosure, when the second image is displayed on the stretchable display, the processor may determine a horizontal-to-vertical ratio of the second image to be equal to a horizontal-to-vertical ratio of the first image.

According to various embodiments of the present disclosure, the processor may acquire a stretch ratio of the stretchable display from the sensor module.

According to various embodiments of the present disclosure, the processor may determine the horizontal-to-vertical ratio of the second image based on the stretch ratio.

According to various embodiments of the present disclosure, the processor may generate the second image by compressing the first image by a reciprocal number of the stretch ratio.

According to various embodiments of the present disclosure, the processor may acquire the first image corresponding to a first partial area cropped from an entire image.

According to various embodiments of the present disclosure, the processor may crop a second partial area from the entire image based on the acquired stretch state, and the second image may be an image corresponding to the second partial area.

According to various embodiments of the present disclosure, the processor may acquire at least one of a stretch direction of the stretchable display and a size of the stretchable display, and crop the second partial area in accordance with at least one of the stretch direction and the size.

According to various embodiments of the present disclosure, the processor may display the second image having a maximum size, which can be cropped when there is no data to be additionally cropped in the entire image.

According to various embodiments of the present disclosure, the processor may acquire a stretch direction of the stretchable display from the sensor module and to display the second image at a location corresponding to the stretch direction.

According to various embodiments of the present disclosure, the processor may include an operation of acquiring a stretch level of the stretchable display from the sensor module and display the second image based on the stretch level.

According to various embodiments of the present disclosure, the processor may acquire display brightness of the second image based on the stretch state and to display the second image with the acquired brightness.

According to various embodiments of the present disclosure, the processor may acquire a stretch level according to each tile of the stretchable display and generate a sub image according to each tile based on the stretch state.

According to various embodiments of the present disclosure, the processor may generate the sub image according to each tile by applying different stretch ratios to tiles having different stretch states.

According to various embodiments of the present disclosure, the processor may display at least one of a black screen, a function tool, second image-related information, and a second image-related application in remaining areas except for an area of the stretchable display in which the second image is displayed.

According to various embodiments of the present disclosure, an electronic device may include: a stretchable display, a detection layer that stretches along with the stretchable display; and a processor that determines at least one of a stretch position and a stretch direction of the stretchable display based on a stretch state of the detection layer.

According to various embodiments of the present disclosure, the detection layer may include a plurality of first linear sensors expanded in an x-axis direction and a plurality of second linear sensors expanded in a y-axis direction, and the processor determines the stretch position based on a stretch level of each of the first linear sensors and each of the second linear sensors.

According to various embodiments of the present disclosure, the processor may determine the stretch direction based on the location of the stretch position relative to the origin of the detection layer.

According to various embodiments of the present disclosure, the detection layer may include a plurality of planar sensors arranged in a matrix form, and the processor determines the stretch position based on a stretch level of each of the planar sensors.

According to various embodiments of the present disclosure, the processor may determine the stretch direction based on the location of the stretch position relative to the origin.

According to various embodiments of the present disclosure, the detection layer may include a plurality of conductive cells, and the processor applies a current to each of the plurality of conductive cells and determines the stretch position based on whether there is an opening between the conductive cell and adjacent conductive cell.

According to various embodiments of the present disclosure, the processor may determine the stretch direction based on a direction between the origin of the detection layer and the stretch position.

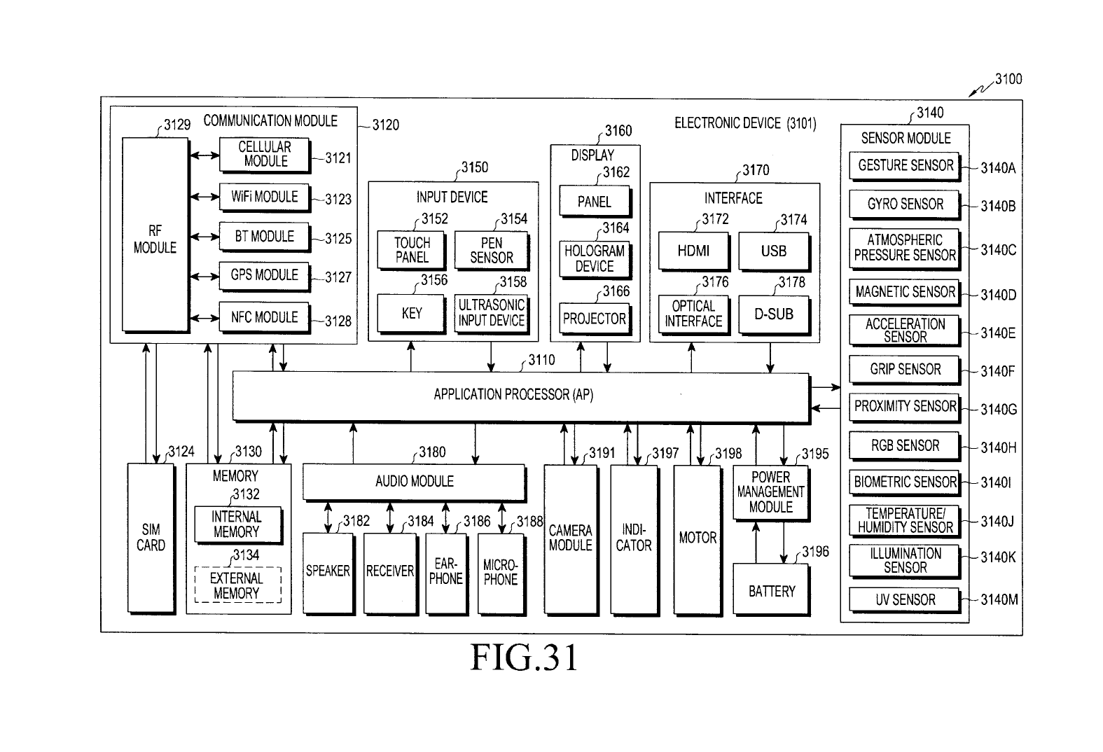

FIG. 31 is a block diagram 3100 of an electronic device 3101 according to various embodiments of the present disclosure. The electronic device 3101 may include, for example, all or some of the electronic device 101 illustrated in FIG. 1. For example, the electronic device 101 illustrated in FIG. 1 may include all or some of the electronic device 3101 illustrated in 31. The electronic device 3101 may include at least one Application Processor (AP) 3110, a communication module 3120, a Subscriber Identification Module (SIM) card 3124, a memory 3130, a sensor module 3140, an input device 3150, a display 3160, an interface 3170, an audio module 3180, a camera module 3191, a power management module 3195, a battery 3196, an indicator 3197, and a motor 3198.

The AP 3110 may control a plurality of hardware or software components connected thereto by driving an operating system or an application program and perform a variety of data processing and calculations. The AP 3110 may be embodied as, for example, a System on Chip (SoC). According to an embodiment of the present disclosure, the AP 3110 may further include a Graphical Processing Unit (GPU) and/or an image signal processor. The AP 3110 may also include at least some (for example, a cellular module 3121) of the components illustrated in FIG. 31. The AP 3110 may load instructions or data, received from at least one other component (for example, a non-volatile memory), in a volatile memory to process the loaded instructions or data, and may store various types of data in a non-volatile memory.

The communication module 3120 may have a configuration equal or similar to the communication interface 170 of FIG. 1. The communication module 3120 may include, for example, a cellular module 3121, a Wi-Fi module 3123, a BT module 3125, a GPS module 3127, an NFC module 3128, and a Radio Frequency (RF) module 3129.

The cellular module 3121 may provide a voice call, video call, text message services, or Internet services through, for example, a communication network. According to an embodiment, the cellular module 3121 may distinguish between and authenticate electronic devices 3101 within a communication network using a subscriber identification module (for example, the SIM card 3124). According to an embodiment of the present disclosure, the cellular module 3121 may perform at least some of the functions which may be provided by the AP 3110. According to an embodiment, the cellular module 3121 may include a Communication Processor (CP).

The Wi-Fi module 3123, the BT module 3125, the GPS module 3127, and the NFC module 3128 may include, for example, a processor for processing data transmitted/received through the corresponding module. According to any embodiment, at least some (two or more) of the cellular module 3121, the Wi-Fi module 3123, the BT module 3125, the GPS module 3127, and the NFC module 3128 may be included in one Integrated Chip (IC) or IC package.

The RF module 3129 may transmit/receive, for example, a communication signal (for example, an RF signal). The RF module 3129 may include, for example, a transceiver, a Power Amp Module (PAM), a frequency filter, a Low Noise Amplifier (LNA) or an antenna. According to another embodiment, at least one of the cellular module 3121, the Wi-Fi module 3123, the BT module 3125, the GPS module 3127, and the NFC module 3128 may transmit/receive an RF signal through a separate RF module.

The SIM card 3124 may include a card including a subscriber identification module and/or an embedded SIM, and contain unique identification information (for example, an Integrated Circuit Card Identifier (ICCID)) or subscriber information (for example, an International Mobile Subscriber Identity (IMSI)).

The memory 3130 (for example, the memory 130) may include, for example, an internal memory 3132 or an external memory 3134. The internal memory 3132 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), mask ROM, a flash ROM, a flash memory (for example, a NAND flash memory or a NOR flash memory), a hard drive, or a Solid State Drive (SSD).

The external memory 3134 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 3134 may be functionally and/or physically connected to the electronic device 3101 through various interfaces.

The sensor module 3140 may measure, for example, a physical quantity or detect an operation state of the electronic device 3101, and may convert the measured or detected information to an electrical signal. The sensor module 3140 may include, for example, at least one of a gesture sensor 3140A, a gyro sensor 3140B, an atmospheric pressure sensor 3140C, a magnetic sensor 3140D, an acceleration sensor 3140E, a grip sensor 3140F, a proximity sensor 3140G, a color sensor 3140H (for example, red, green, and blue (RGB) sensor), a biometric sensor 3140I, a temperature/humidity sensor 3140J, an illumination sensor 3140K, and an Ultra Violet (UV) sensor 3140M. Additionally or alternatively, the sensor module 3140 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 3140 may further include a control circuit for controlling at least one sensor included therein. In any embodiment, the electronic device 3101 may further include a processor configured to control the sensor module 3140 as a part of or separately from the AP 3110, and may control the sensor module 3140 while the AP 3110 is in a sleep state.

The input device 3150 may include, for example, a touch panel 3152, a (digital) pen sensor 3154, a key 3156, or an ultrasonic input device 3158. The touch panel 3152 may use at least one of, for example, a capacitive type, a resistive type, an infrared type, and an ultrasonic type. The touch panel 3152 may further include a control circuit. The touch panel 3152 may further include a tactile layer, and provide a tactile reaction to a user.

The (digital) pen sensor 3154 may include, for example, a recognition sheet which is a part of the touch panel or a separate recognition sheet. The key 3156 may include, for example, a physical button, an optical key or a keypad. The ultrasonic input unit 3158 may input data through an input means that generates an ultrasonic signal, and the electronic device 3101 identify data by detecting a sound wave with a microphone (for example, a microphone 3188).

The display 3160 (for example, the display 160) may include a panel 3162, a hologram device 3164 or a projector 3166. The panel 3162 may include a component equal or similar to the display 160 of FIG. 1. The panel 3162 may be embodied to be, for example, flexible, transparent, or wearable. The panel 3162 may also be configured to be integrated with the touch panel 3152 as a single module. The hologram device 3164 may show a stereoscopic image in the air by using interference of light. The projector 3166 may project light onto a screen to display an image. For example, the screen may be located inside or outside the electronic device 3101. According to an embodiment, the display 3160 may further include a control circuit for controlling the panel 3162, the hologram device 3164, or the projector 3166.

The interface 3170 may include, for example, a High-Definition Multimedia Interface (HDMI) 3172, a Universal Serial Bus (USB) 3174, an optical interface 3176, or a D-subminiature (D-sub) 3178. The interface 3170 may be included in, for example, the communication interface 170 illustrated in FIG. 1. Additionally or alternatively, the interface 3170 may include, for example, a Mobile High-definition Link (MHL) interface, a Secure Digital (SD) card/Multi-Media Card (MMC) interface, or an Infrared Data Association (IrDA) standard interface.

The audio module 3180 may bilaterally convert, for example, a sound and an electrical signal. At least some components of the audio module 3180 may be included in, for example, the input/output interface 140 illustrated in FIG. 1. The audio module 3180 may process sound information input or output through, for example, a speaker 3182, a receiver 3184, earphones 3186, the microphone 3188, or the like.

The camera module 3191 is a device which may photograph a still image and a dynamic image. According to an embodiment, the camera module 3191 may include one or more image sensors (for example, a front sensor or a back sensor), a lens, an Image Signal Processor (ISP) or a flash (for example, LED or xenon lamp).

The power management module 3195 may manage, for example, the power supply of the electronic device 3101. According to an embodiment, the power management module 3195 may include a Power Management Integrated Circuit (PMIC), a charger Integrated Circuit (IC), or a battery or fuel gauge. The PMIC may have a wired and/or wireless charging scheme. Examples of the wireless charging method may include, for example, a magnetic resonance method, a magnetic induction method, an electromagnetic method, and the like. Additional circuits (for example, a coil loop, a resonance circuit, a rectifier, and the like) for wireless charging may be further included. The battery gauge may measure, for example, the remaining amount of battery 3196, a charging voltage and current, or temperature. The battery 3196 may include, for example, a rechargeable battery and/or a solar battery.

The indicator 3197 may indicate a particular status of the electronic device 3101 or a part thereof (for example, the AP 3110), for example, a booting status, a message status, a charging status, or the like. The motor 3198 may convert an electrical signal into mechanical vibrations, and may generate a vibration or haptic effect. Although not illustrated, the electronic device 3101 may include a processing device (for example, a GPU) for supporting mobile TV. The processing device for supporting mobile TV may process media data according to a standard of Digital Multimedia Broadcasting (DMB), Digital Video Broadcasting (DVB), media flow or the like.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

The term “module” used in the present disclosure may refer to, for example, a unit including one or more combinations of hardware, software, and firmware. The “module” may be interchangeable with a term, such as a unit, a logic, a logical block, a component, or a circuit. The “module” may be the smallest unit of an integrated component or a part thereof. The “module” may be a minimum unit for performing one or more functions or a part thereof. The “module” may be mechanically or electronically implemented.

According to various embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor 120), the one or more processors may execute a function corresponding to the command. The computer-readable storage medium may be, for example, the memory 130.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

FIGS. 1-31 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. A method comprising:
acquiring, by an electronic device, a first image;
acquiring a stretch state of a stretchable display of the electronic device;
generating, by the electronic device, a second image based on the first image and the stretch state; and
displaying the second image on the stretchable display.

2. The method of claim 1, wherein the second image has a same aspect ratio as the first image.

3. The method of claim 2, wherein acquiring the stretch state comprises acquiring a stretch ratio of the stretchable display.

4. The method of claim 3, wherein the second image is generated based on the stretch ratio.

5. The method of claim 3, wherein the second image is generated by compressing the first image based on a reciprocal of the stretch ratio.

6. The method of claim 1, wherein acquiring the first image includes cropping a first portion of a base image.

7. The method of claim 6, wherein generating the second image includes cropping a second portion of the base image.

8. The method of claim 7, wherein:
acquiring the stretch state comprises acquiring at least one of a direction in which the stretchable display is stretched and a size to which the stretchable display is stretched, and
the second portion of the base image is cropped in accordance with at least one of the direction in which the stretchable display is stretched and the size to which the stretchable display is stretched.

9. The method of claim 6, wherein displaying the second image comprises displaying the base image when a predetermined condition is satisfied.

10. The method of claim 1, wherein:
acquiring the stretch state comprises acquiring a direction in which the stretchable display is stretched, and
the second image is displayed at a location in the stretchable display that is selected by the electronic device based on the direction in which the stretchable display is stretched.

11. The method of claim 1, wherein:
acquiring the stretch state comprises detecting an extent to which the stretchable display is stretched, and
the second image is displayed based on the extent to which the stretchable display is stretched.

12. The method of claim 1, wherein displaying the second image includes adjusting a brightness of the stretchable display based on the stretch state.

13. The method of claim 1, further comprising dividing the first image into a plurality of first tiles, wherein:
acquiring the stretch state comprises acquiring a different respective stretch state of each of the plurality of first tiles, and
generating the second image comprises generating a plurality of second tiles, each second tile being generated based on a different one of the plurality of first tiles and that first tile's respective stretch state.

14. The method of claim 13, wherein the plurality of second tiles is generated by applying different stretch ratios to the plurality of first tiles.

15. The method of claim 1, further comprising displaying, while the second image is displayed, at least one of a black screen, a function tool, second image-related information, and a second image-related application in one or more areas of the stretchable display that are not occupied by the second image.

16. A method for use in an electronic device comprising:
displaying a first image on a stretchable display of the electronic device, the stretchable display having a first size;
detecting that the stretchable display is stretched from the first size to a second size; and
displaying a second image that is generated by resizing the first image based on the second size such that the first image and the second image have same aspect ratio.

17. An electronic device comprising:
a memory;
a stretchable display;
a sensor module; and
at least one processor operatively coupled to the memory, configured to:
acquire a first image;
acquire a stretch state of the stretchable display by using the sensor module;
generate a second image based on the first image and the stretch state; and
display the second image on the stretchable display

18. The electronic device of claim 17, wherein the second image has a same aspect ratio as the first image.

19. The electronic device of claim 18, wherein acquiring the stretch state comprises acquiring a stretch ratio of the stretchable display.

20. The electronic device of claim 19, wherein the second image is generated based on the stretch ratio.
